(19) United States
(12) Patent Application Publication
(10) Pub. No.: US 2025/0081120 A1
(43) Pub. Date: Mar. 6, 2025

(54) POWER BOOSTING AND ENERGY HARVESTING SLOT INDICATIONS

(71) Applicant: QUALCOMM Incorporated, San Diego, CA (US)

(72) Inventors: Ahmed ELSHAFIE, San Diego, CA (US); Ahmed Attia ABOTABL, San Diego, CA (US); Alexandros MANOLAKOS, Athens (GR)

(21) Appl. No.: 18/701,773

(22) PCT Filed: Nov. 21, 2022
(86) PCT No.: PCT/US2022/050570

§ 371 Date: Apr. 16, 2024

(30) Foreign Application Priority Data
Dec. 29, 2021 (GR) 20210100919

(51) Int. Cl. H04W 52/16; H02J 50/00; H04W 52/34

(52) U.S. Cl. CPC H04W 52/16; H02J 50/001; H04W 52/34

(57) ABSTRACT

Aspects relate to power boosting for concurrent decoding and energy harvesting. A wireless communication device may receive a power boosting parameter indicating a power boosting amount for energy harvesting. The wireless communication device may further receive a first portion of a transmission at a first power and a second portion of a transmission at a second power higher than the first power. The wireless communication device may concurrently decode and harvest energy from the second portion of the transmission using a power splitting factor based on the power boosting parameter. Aspects further relate to indicating slots for energy harvesting. For example, a wireless communication device may receive a slot including control information that is located within a control resource set or scrambled with a radio network temporary identifier indicating a slot type of the slot.

### CROSS-REFERENCE TO RELATED APPLICATION

The present Application for Patent claims priority to Greece application No. 20210100919, filed Dec. 29, 2021, and assigned to the assignee hereof and hereby expressly incorporated by reference herein as if fully set forth below and for all applicable purposes.

### TECHNICAL FIELD

The technology discussed below relates generally to wireless communication networks, and more particularly, to mechanisms for indicating slots for energy harvesting and power boosting for shared data and energy harvesting symbols.

### INTRODUCTION

The 5G New Radio (NR) mobile telecommunication systems can provide higher data rates, lower latency, and improved system performance than previous generation systems. In addition, the 3rd Generation Partnership Project (3GPP) has specified several cellular technologies for applications related to the Internet of Things (IoT) in licensed spectrum, including Long Term Evolution (LTE) for machine-type communications (LTE-M), narrowband IoT (NB-IoT) supporting massive machine type communication (mMTC), extended-coverage GSM for IoT (EC-GSM-IoT), and ultra-reliable low-latency communications (URLLC). Applications include, for example, sensors, surveillance cameras, wearable devices, smart meters and smart meter sensors. To meet the power requirements in 5G NR and IoT wireless communications, wireless communication devices (e.g., user equipment (UEs)) may be configured to perform radio frequency (RF) energy harvesting to accumulate energy over time. The accumulated energy can charge a power source (e.g., a battery) of the wireless communication device to perform various tasks, such as data reception, data decoding, data encoding, and data transmission.

Energy harvesting may be utilized for both cellular communications and for sidelink communications. For cellular communications, a cellular network may enable user equipment (UEs) to communicate with one another through signaling with a nearby base station or cell. For sidelink communications, UEs may signal one another directly, rather than via an intermediary base station or cell. In some sidelink network configurations, UEs may further communicate in a cellular network, generally under the control of a base station. Thus, the UEs may be configured for uplink and downlink signaling via a base station and further for sidelink signaling directly between the UEs without transmissions passing through the base station.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a wireless communication device configured for wireless communication is provided. The wireless communication device includes a transceiver, a memory, and a processor coupled to the transceiver and the memory. The processor and the memory can be configured to receive a message including a power boosting parameter indicating a power boosting amount for energy harvesting of a transmission via the transceiver, receiving a first portion of the transmission at a first power via the transceiver, receiving a second portion of the transmission at a second power higher than the first power via the transceiver, and concurrently decoding and harvesting energy from the second portion of the transmission using a power splitting factor applied to the second power. The power splitting factor being based on the power boosting parameter.

Another example provides a method for wireless communication at a wireless communication device. The method includes receiving a message including a power boosting parameter indicating a power boosting amount for energy harvesting of a transmission, receiving a first portion of the transmission at a first power, receiving a second portion of the transmission at a second power higher than the first power, and concurrently decoding and harvesting energy from the second portion of the transmission using a power splitting factor applied to the second power. The power splitting factor being based on the power boosting parameter.

Another example provides a wireless communication device configured for wireless communication is provided. The wireless communication device includes a transceiver, a memory, and a processor coupled to the transceiver and the memory. The processor and the memory can be configured to receive control information within a first portion of a slot via the transceiver. The control information being at least one of located within a control resource set (CORESET) or scrambled with a radio network temporary identifier (RNTI) indicating a slot type of a slot. The slot type including an energy harvesting slot type, an energy harvesting and data reception slot type, or a data reception slot type. The processor and the memory can further be configured to receive a second portion of the slot based on the slot type via the transceiver.

Another example provides a method for wireless communication at a wireless communication device. The method includes receiving control information within a first portion of a slot. The control information being at least one of located within a control resource set (CORESET) or scrambled with a radio network temporary identifier (RNTI) indicating a slot type of a slot. The slot type including an energy harvesting slot type, an energy harvesting and data reception slot type, or a data reception slot type. The method further includes receiving a second portion of the slot based on the slot type.

These and other aspects will become more fully understood upon a review of the detailed description, which follows. Other aspects, features, and examples will become apparent to those of ordinary skill in the art, upon reviewing the following description of specific, exemplary examples of in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices, systems, and methods.

### BRIEF DESCRIPTION OF THE DRAWINGS

FIG. 1 is a diagram illustrating an example of a wireless radio access network according to some aspects.

FIG. 2 is a diagram illustrating an example of a frame structure for use in a wireless communication network according to some aspects.

FIG. 3 is a diagram illustrating exemplary cellular slot structures according to some aspects of the disclosure.

FIG. 4 is a schematic illustration of an example of control resource sets (CORESETs) according to some aspects.

FIG. 5 is a diagram illustrating an example of a wireless communication network employing sidelink communication according to some aspects.

FIGS. 6A and 6B are diagram illustrating examples of sidelink slot structures according to some aspects.

FIG. 7 is a diagram illustrating an example of energy harvesting according to some aspects.

FIGS. 8A, 8B, and 8C are diagrams illustrating examples of energy harvesting receiver architectures according to some aspects.

FIG. 9 is a graph illustrating a piece-wise linear energy harvesting model according to some aspects.

FIGS. 10A and 10B are diagrams illustrating exemplary energy harvesting power boosting of transmissions according to some aspects.

FIG. 11 is a signaling diagram illustrating exemplary signaling for energy harvesting power boosting of transmissions according to some aspects.

FIG. 12 is a diagram illustrating exemplary slot types according to some aspects.

FIG. 13 is a diagram illustrating exemplary circuitry for generating control information having an RNTI or CORESET indicating a slot type according to some aspects.

FIG. 14A is a diagram illustrating examples of a single DCI scheduling multiple slots according to some aspects.

FIG. 14B is a diagram illustrating an example of downlink control information scheduling a plurality of slots according to some aspects.

FIG. 15 is a block diagram illustrating an example of a hardware implementation for a wireless communication device employing a processing system according to some aspects.

FIG. 16 is a flow chart of an exemplary method for power boosting for shared data and energy harvesting symbols according to some aspects.

FIG. 17 is a flow chart of another exemplary method for power boosting for shared data and energy harvesting symbols according to some aspects.

FIG. 18 is a flow chart of another exemplary method for power boosting for shared data and energy harvesting symbols according to some aspects.

FIG. 19 is a flow chart of a method for identifying a slot type of a slot according to some aspects.

FIG. 20 is a flow chart of a method for processing a slot based on the slot type of the slot according to some aspects.

FIG. 21 is a flow chart of a method for applying power boosting to a transmission received within a slot based on the slot type according to some aspects.

FIG. 22 is a flow chart of a method for receiving a plurality of slots based on the respective slot types of each of the slots according to some aspects.

FIG. 23 is a block diagram illustrating an example of a hardware implementation for a base station employing a processing system according to some aspects.

FIG. 24 is a flow chart of an exemplary method for power boosting for shared data and energy harvesting symbols according to some aspects.

FIG. 25 is a flow chart of an exemplary method for indicating a slot type of a slot according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station or UE), end-user devices, etc. of varying sizes, shapes and constitution.

In various aspects of the disclosure, a transmitting device, such as a base station, UE, or other sidelink/V2X/IoT device, can boost the transmit power of a transmission (e.g., an RF signal) above a threshold power. A receiving device (e.g., a wireless communication device, such as a UE or other sidelink/V2X/IoT device), can leverage the excess power in decoding (e.g., by increasing the signal-to-noise-plus-interference ratio (SINR) of the data) to optimize performance of data decoding and energy harvesting.

In some examples, the transmitting device can transmit a power boosting parameter indicating the power boosting applied to the transmission (e.g., a downlink transmission or a sidelink transmission) to the receiving device. Based on the power boosting parameter, the receiving device can set a power splitting factor (PSF) for concurrent (e.g., simultaneous) data decoding and energy harvesting of the transmission. In some examples, the power boosting parameter may indicate the energy harvesting power boosting of a second portion of a transmission relative to the power of a first portion of the transmission. Thus, the transmission may include a first portion transmitted at a first power and a second portion transmitted at a second power higher than the first power based on the power boosting parameter. The first portion of the transmission may include, for example, control information, whereas the second portion of the transmission may include, for example, data.

In addition to power boosting for shared data and energy harvesting symbols, various aspects can provide mechanisms to indicate slots that may be used for energy harvesting only, data reception only, or a combination of energy harvesting and data reception using time-switching or power-splitting with or without power boosting.

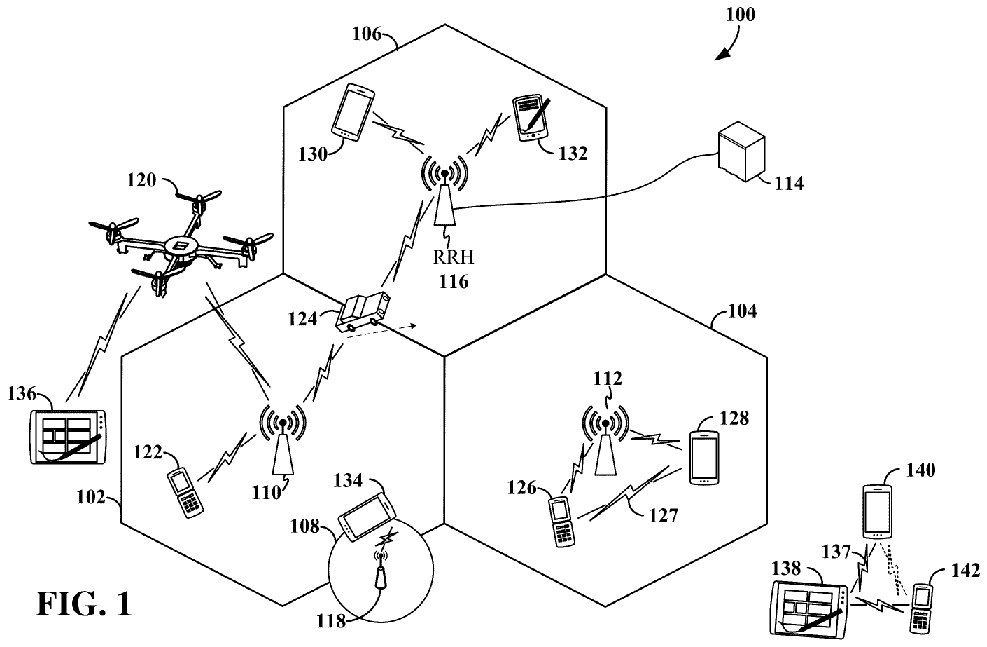

The various concepts presented throughout this disclosure may be implemented across a broad variety of telecommunication systems, network architectures, and communication standards. Referring now to FIG. 1, as an illustrative example without limitation, a schematic illustration of a radio access network 100 is provided. The RAN 100 may implement any suitable wireless communication technology or technologies to provide radio access. As one example, the RAN 100 may operate according to 3rd Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

The geographic region covered by the radio access network 100 may be divided into a number of cellular regions (cells) that can be uniquely identified by a user equipment (UE) based on an identification broadcasted over a geographical area from one access point or base station. FIG. 1 illustrates cells 102, 104, 106, and cell 108, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective base station (BS) serves each cell. Broadly, a base station is a network element in a radio access network responsible for radio transmission and reception in one or more cells to or from a UE. A BS may also be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 100 operates according to both the LTE and 5G NR standards, one of the base stations may be an LTE base station, while another base station may be a 5G NR base station.

Various base station arrangements can be utilized. For example, in FIG. 1, two base stations 110 and 112 are shown in cells 102 and 104; and a third base station 114 is shown controlling a remote radio head (RRH) 116 in cell 106. That is, a base station can have an integrated antenna or can be connected to an antenna or RRH by feeder cables. In the illustrated example, the cells 102, 104, and 106 may be referred to as macrocells, as the base stations 110, 112, and 114 support cells having a large size. Further, a base station 118 is shown in the cell 108 which may overlap with one or more macrocells. In this example, the cell 108 may be referred to as a small cell (e.g., a microcell, picocell, femtocell, home base station, home Node B, home eNode B, etc.), as the base station 118 supports a cell having a relatively small size. Cell sizing can be done according to system design as well as component constraints.

It is to be understood that the radio access network 100 may include any number of wireless base stations and cells. Further, a relay node may be deployed to extend the size or coverage area of a given cell. The base stations 110, 112, 114, 118 provide wireless access points to a core network for any number of mobile apparatuses.

FIG. 1 further includes an unmanned aerial vehicle (UAV) 120, which may be a drone or quadcopter. The UAV 120 may be configured to function as a base station, or more specifically as a mobile base station. That is, in some examples, a cell may not necessarily be stationary, and the geographic area of the cell may move according to the location of a mobile base station such as the UAV 120.

In general, base stations may include a backhaul interface for communication with a backhaul portion (not shown) of the network. The backhaul may provide a link between a base station and a core network (not shown), and in some examples, the backhaul may provide interconnection between the respective base stations. The core network may be a part of a wireless communication system and may be independent of the radio access technology used in the radio access network. Various types of backhaul interfaces may be employed, such as a direct physical connection, a virtual network, or the like using any suitable transport network.

The RAN 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with base station 118; and UE 136 may be in communication with mobile base station 120. Here, each base station 110, 112, 114, 118, and 120 may be configured to provide an access point to a core network (not shown) for all the UEs in the respective cells. In some examples, the UAV 120 (e.g., the quadcopter) can be a mobile network node and may be configured to function as a UE. For example, the UAV 120 may operate within cell 102 by communicating with base station 110.

Wireless communication between a RAN 100 and a UE (e.g., UE 122 or 124) may be described as utilizing an air interface. Transmissions over the air interface from a base station (e.g., base station 110) to one or more UEs (e.g., UE 122 and 124) may be referred to as downlink (DL) transmission. In accordance with certain aspects of the present disclosure, the term downlink may refer to a point-to-multipoint transmission originating at a scheduling entity (described further below; e.g., base station 110). Another way to describe this scheme may be to use the term broadcast channel multiplexing. Transmissions from a UE (e.g., UE 122) to a base station (e.g., base station 110) may be referred to as uplink (UL) transmissions. In accordance with further aspects of the present disclosure, the term uplink may refer to a point-to-point transmission originating at a scheduled entity (described further below; e.g., UE 122).

For example, DL transmissions may include unicast or broadcast transmissions of control information and/or traffic information (e.g., user data traffic) from a base station (e.g., base station 110) to one or more UEs (e.g., UEs 122 and 124), while UL transmissions may include transmissions of control information and/or traffic information originating at a UE (e.g., UE 122). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In some examples, access to the air interface may be scheduled, wherein a scheduling entity (e.g., a base station) allocates resources (e.g., time-frequency resources) for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

Base stations are not the only entities that may function as a scheduling entity. That is, in some examples, a UE may function as a scheduling entity, scheduling resources for one or more scheduled entities (e.g., one or more other UEs). For example, two or more UEs (e.g., UEs 138, 140, and 142) may communicate with each other using sidelink signals 137 without relaying that communication through a base station. In some examples, the UEs 138, 140, and 142 may each function as a scheduling entity or transmitting sidelink device and/or a scheduled entity or a receiving sidelink device to schedule resources and communicate sidelink signals 137 therebetween without relying on scheduling or control information from a base station. In other examples, two or more UEs (e.g., UEs 126 and 128) within the coverage area of a base station (e.g., base station 112) may also communicate sidelink signals 127 over a direct link (sidelink) without conveying that communication through the base station 112. In this example, the base station 112 may allocate resources to the UEs 126 and 128 for the sidelink communication. In either case, such sidelink signaling 127 and 137 may be implemented in a peer-to-peer (P2P) network, a device-to-device (D2D) network, a vehicle-to-vehicle (V2V) network, a vehicle-to-everything (V2X) network, a mesh network, or other suitable direct link network.

In some examples, a D2D relay framework may be included within a cellular network to facilitate relaying of communication to/from the base station 112 via D2D links (e.g., sidelinks 127 or 137). For example, one or more UEs (e.g., UE 128) within the coverage area of the base station 112 may operate as relaying UEs to extend the coverage of the base station 112, improve the transmission reliability to one or more UEs (e.g., UE 126), and/or to allow the base station to recover from a failed UE link due to, for example, blockage or fading.

Two primary technologies that may be used by V2X networks include dedicated short range communication (DSRC) based on IEEE 802.11p standards and cellular V2X based on LTE and/or 5G (New Radio) standards. Various aspects of the present disclosure may relate to New Radio (NR) cellular V2X networks, referred to herein as V2X networks, for simplicity. However, it should be understood that the concepts disclosed herein may not be limited to a particular V2X standard or may be directed to sidelink networks other than V2X networks.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 100, the ability for a UE to communicate while moving, independent of their location, is referred to as mobility. The various physical channels between the UE and the RAN are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In some examples, a RAN 100 may enable mobility and handovers (i.e., the transfer of a UE's connection from one radio channel to another). For example, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

In various implementations, the air interface in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The air interface in the RAN 100 may utilize one or more multiplexing and multiple access algorithms to enable simultaneous communication of the various devices. For example, 5G NR specifications provide multiple access for UL or reverse link transmissions from UEs 122 and 124 to base station 110, and for multiplexing DL or forward link transmissions from the base station 110 to UEs 122 and 124 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

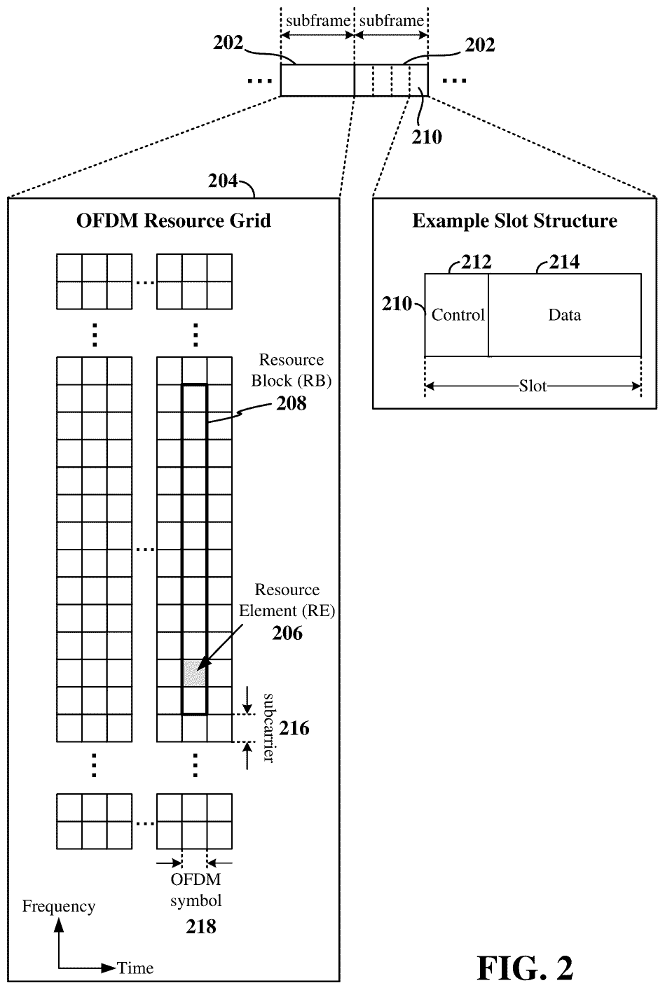

Various aspects of the present disclosure will be described with reference to an OFDM waveform, schematically illustrated in FIG. 2. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 2, an expanded view of an exemplary subframe 202 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols 218; and frequency is in the vertical direction with units of subcarriers 216 of the carrier.

The resource grid 204 may be used to schematically represent time-frequency resources for a given antenna port. That is, in a multiple-input-multiple-output (MIMO) implementation with multiple antenna ports available, a corresponding multiple number of resource grids 204 may be available for communication. The resource grid 204 is divided into multiple resource elements (REs) 206. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 208, which contains any suitable number of consecutive subcarriers 216 in the frequency domain. In one example, an RB may include 12 subcarriers, a number independent of the numerology used. In some examples, depending on the numerology, an RB may include any suitable number of consecutive OFDM symbols 218 in the time domain. Within the present disclosure, it is assumed that a single RB such as the RB 208 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of UEs or sidelink devices (hereinafter collectively referred to as UEs) for downlink, uplink, or sidelink transmissions typically involves scheduling one or more resource elements 206 within one or more sub-bands or bandwidth parts (BWPs). Thus, a UE generally utilizes only a subset of the resource grid 204. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.) or may be self-scheduled by a UE/sidelink device implementing D2D sidelink communication.

In this illustration, the RB 208 is shown as occupying less than the entire bandwidth of the subframe 202, with some subcarriers illustrated above and below the RB 208. In a given implementation, the subframe 202 may have a bandwidth corresponding to any number of one or more RBs 208. Further, in this illustration, the RB 208 is shown as occupying less than the entire duration of the subframe 202, although this is merely one possible example.

Each 1 ms subframe 202 may consist of one or multiple adjacent slots. In the example shown in FIG. 2, one subframe 202 includes four slots 210, as an illustrative example. In some examples, a slot may be defined according to a specified number of OFDM symbols with a given cyclic prefix (CP) length. For example, a slot may include 7 or 12 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 210 illustrates the slot 210 including a control region 212 and a data region 214. In general, the control region 212 may carry control channels, and the data region 214 may carry data channels. Of course, a slot may contain all DL, all UL, or at least one DL portion and at least one UL portion. The structure illustrated in FIG. 2 is merely exemplary in nature, and different slot structures may be utilized, and may include one or more of each of the control region(s) and data region(s).

Although not illustrated in FIG. 2, the various REs 206 within a RB 208 may be scheduled to carry one or more physical channels, including control channels, shared channels, data channels, etc. Other REs 206 within the RB 208 may also carry pilots or reference signals. These pilots or reference signals may provide for a receiving device to perform channel estimation of the corresponding channel, which may enable coherent demodulation/detection of the control and/or data channels within the RB 208.

In some examples, the slot 210 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 206 (e.g., within the control region 212) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 206 (e.g., in the control region 212 or the data region 214) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 20, 80, or 120 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information.

In an UL transmission, the scheduled entity (e.g., UE) may utilize one or more REs 206 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 206 (e.g., within the data region 214) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 206 within the data region 214 may be configured to carry other signals, such as one or more SIBs and DMRSs.

In an example of sidelink communication over a sidelink carrier via a PC5 interface, the control region 212 of the slot 210 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 214 of the slot 210 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 206 within slot 210. For example, HARQ feedback information may be transmitted in a physical sidelink feedback channel (PSFCH) within the slot 210 from the receiving sidelink device to the transmitting sidelink device. In addition, one or more reference signals, such as a sidelink SSB, a sidelink CSI-RS, a sidelink SRS, a sidelink DMRS, and/or a sidelink positioning reference signal (PRS) may be transmitted within the slot 210.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 2 are not necessarily all of the channels or carriers that may be utilized between devices, and those of ordinary skill in the art will recognize that other channels or carriers may be utilized in addition to those illustrated, such as other traffic, control, and feedback channels.

In 5G NR, each symbol 218 of each slot 210 may be configurable as a downlink symbol (D), an uplink symbol (U), or a flexible symbol (F). Flexible symbols (F) may be used to carry downlink or uplink information, depending on the slot configuration. Thus, the structure of a particular slot 210 may include all downlink symbols, all uplink symbols, or a mixture of downlink, uplink, and flexible symbols. The slot structure configuration of each slot may be signaled in a static, semi-static, or fully dynamic fashion. For example, the slot format configuration can be broadcast within SIB1 and/or configured via a radio resource control (RRC) message for static or semi-static configurations or can be transmitted via DCI for dynamic configurations.

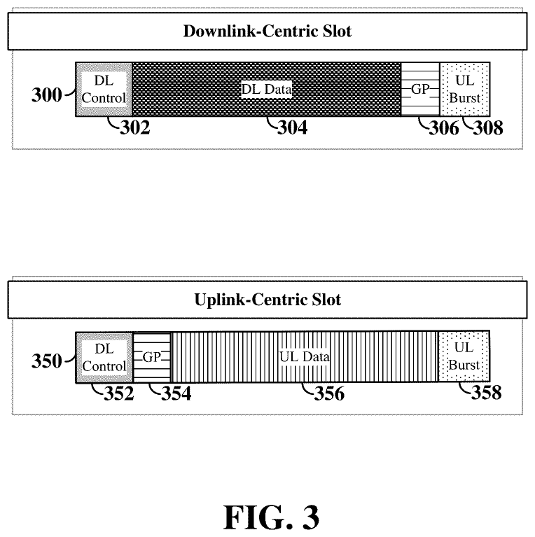

In some examples, one or more slots may be structured as mixed slots, which contain both downlink and uplink symbols. For example, FIG. 3 illustrates two example structures of mixed slots 300 and 350 according to some examples. The mixed slots 300 and/or 350 may be used, in some examples, in place of the slot 210 described above and illustrated in FIG. 2.

In the illustrated example, a downlink (DL)-centric slot 300 may be a transmitter-scheduled slot. The nomenclature DL-centric generally refers to a structure in which more resources are allocated for transmissions in the DL direction (e.g., transmissions from the base station to the UE). Similarly, an uplink (UL)-centric slot 350 may be a receiver-scheduled slot, in which more resources are allocated for transmissions in the UL direction (e.g., transmissions from the UE to the base station).

Each of the mixed slots 300 and 350, may include transmit (Tx) and receive (Rx) portions. For example, in the DL-centric slot 300, the base station first has an opportunity to transmit control information, e.g., on a PDCCH, in a DL control region 302, and then an opportunity to transmit DL user data or traffic, e.g., on a PDSCH in a DL data region 304. Following a guard period (GP) region 306 having a suitable duration, the base station has an opportunity to receive UL data and/or UL feedback including any UL scheduling requests, CSF, a HARQ ACK/NACK, etc., in an UL burst 308 from other entities (e.g., UEs) using the carrier. Here, a slot such as the DL-centric slot 300 may be referred to as a self-contained slot when all of the data carried in the data region 304 is scheduled in the control region 302 of the same slot; and further, when all of the data carried in the data region 304 is acknowledged (or at least has an opportunity to be acknowledged) in the UL burst 308 of the same slot. In this way, each self-contained slot may be considered a self-contained entity, not necessarily requiring any other slot to complete a scheduling-transmission-acknowledgment cycle for any given packet.

The GP region 306 may be included to accommodate variability in UL and DL timing. For example, latencies due to radio frequency (RF) antenna direction switching (e.g., from DL to UL) and transmission path latencies may cause the UE to transmit early on the UL to match DL timing. Such early transmission may interfere with symbols received from the base station. Accordingly, the GP region 306 may allow an amount of time after the DL data region 304 to prevent interference, where the GP region 306 provides an appropriate amount of time for the base station to switch its RF antenna direction, an appropriate amount of time for the over-the-air (OTA) transmission, and an appropriate amount of time for ACK processing by the UE.

The UL-centric slot 350 is substantially similar to the DL-centric slot 300, including a DL control region 352, a guard period (GP) 354, an UL data region 356, and an UL burst region 358. For example, in the UL-centric slot 350, one or more UEs first have an opportunity to receive control information, e.g., on a PDCCH, in a DL control region 352, and then after a suitable GP 354, the UE(s) have an opportunity to transmit UL user data or traffic, e.g., on a PDSCH in the UL data region 356. The UE(s) then have an opportunity to further transmit UL data and/or UL feedback including any UL scheduling requests, CSF, a HARQ ACK/NACK, etc., in the UL burst 358.

The slot structures illustrated in slots 300 and 350 are merely exemplary of mixed slots. Other examples may include slot structures with different DL/UL portions or structures with all downlink symbols or all uplink symbols. Other examples still may be provided within the scope of the present disclosure.

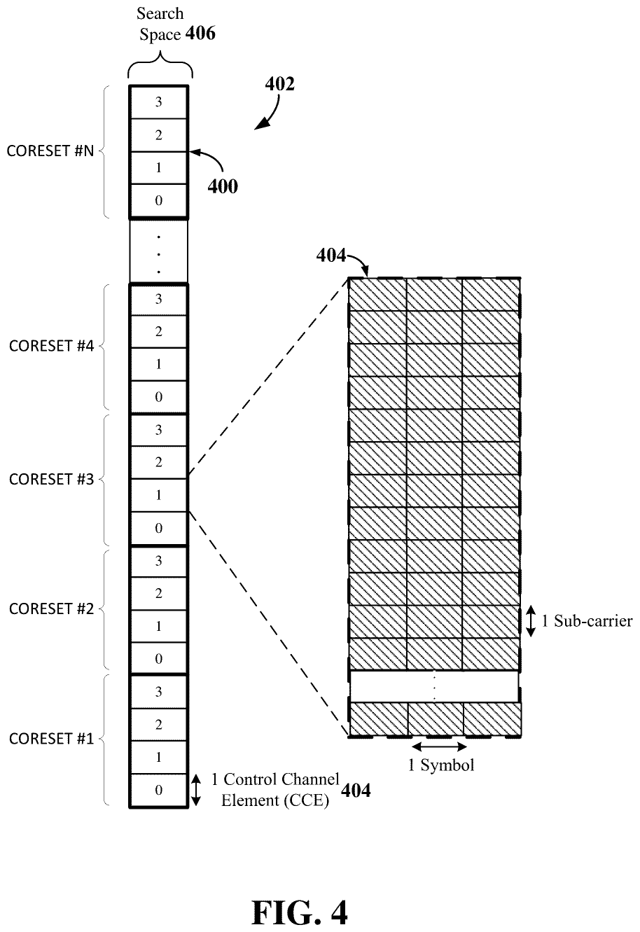

FIG. 4 is a schematic illustration of a number of example control resource sets (CORESETs) 400 of a DL control portion 402 of a slot according to some aspects. The DL control portion 402 may correspond, for example, to the DL control portion 302 or 352 illustrated in FIG. 3. A CORESET 400 may be configured for group common control information or UE-specific control information and may be used for transmission of a PDCCH including the group common control information or UE-specific control information to a set of one or more UEs. The UE may monitor one or more CORESETs 400 that the UE is configured to monitor for the UE-specific or group common control information.

Each CORESET 400 represents a portion of the DL control portion 402 including a number of sub-carriers in the frequency domain and one or more symbols in the time domain. In the example of FIG. 4, each CORESET 400 includes at least one control channel element (CCE) 404 having dimensions in both frequency and time, sized to span across three OFDM symbols. A CORESET having a size that spans across two or more OFDM symbols may be beneficial for use over a relatively small system bandwidth (e.g., 5 MHz). However, a one-symbol CORESET may also be possible.

A plurality of CORESETs 400 indexed as CORESET #1-CORESET #N are shown as occurring during three OFDM symbols in the time domain and occupying a first region of frequency resources in the frequency domain of the DL control portion 402. In the example shown in FIG. 4, each CORESET 400 include four CCEs 404. It should be noted that this is just one example. In another example, each CORESET 400 may include any suitable number of CCEs 404. The number of CCEs 404 and configuration of CCEs 404 for each CORESET 400 may be dependent, for example, on the aggregation level applied to the PDCCH.

For example, a search space for a UE may be indicated by a set of contiguous CCEs that the UE should monitor for downlink assignments and uplink grants relating to a particular component carrier for the UE. In the example shown in FIG. 4, the plurality of CORESETs 400 may form a search space 406, which may be a UE-specific search space (USS) or a common search space (CSS). Within a USS, the aggregation level of a PDCCH may be, for example, 1, 2, 4, or 8 consecutive CCEs and within a CSS, the aggregation level of the PDCCH may be, for example 4 or 8 consecutive CCEs. In addition, the number of PDCCH candidates within each search space may vary depending on the aggregation level utilized. For example, for a USS with an aggregation level of 1 or 2, the number of PDCCH candidates may be 6. In this example, the number of CCEs in the USS search space 406 for an aggregation level of 1 may be 6, and the number of CCEs in the USS search space 406 for an aggregation level of 2 may be 12. However, for a USS with an aggregation level of 4 or 8, the number of PDCCH candidates may be 2. In this example, the number of CCEs in the USS search space 406 for an aggregation level of 4 may be 8, and the number of CCEs in the USS search space 406 for an aggregation level of 8 may be 16. For a CSS search space 406, the number of CCEs in the search space 406 may be 16 regardless of the aggregation level.

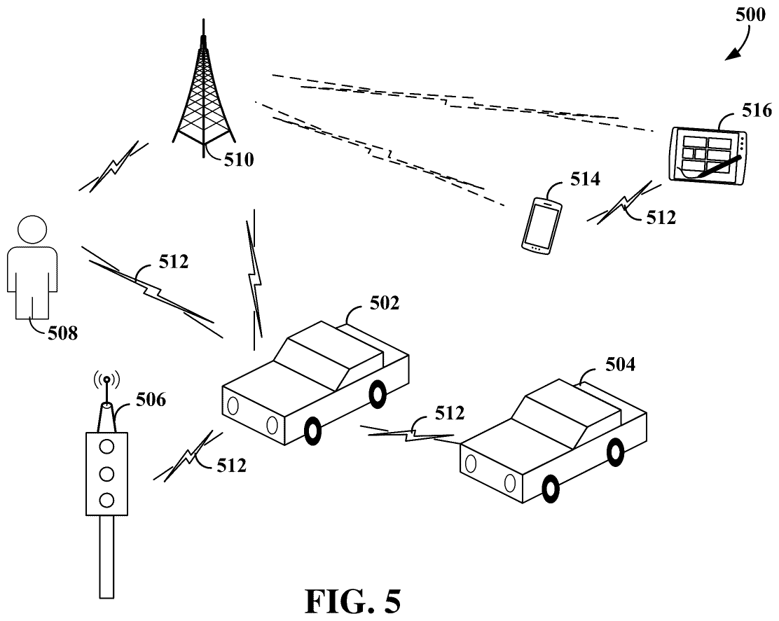

FIG. 5 illustrates an example of a wireless communication network 500 configured to support sidelink communication. In some examples, sidelink communication may include V2X communication. V2X communication involves the wireless exchange of information directly between not only vehicles (e.g., vehicles 502 and 504) themselves, but also directly between vehicles 502/504 and infrastructure (e.g., roadside units (RSUs) 506), such as streetlights, buildings, traffic cameras, tollbooths or other stationary objects, vehicles 502/504 and pedestrians 508, and vehicles 502/504 and wireless communication networks (e.g., base station 510). In some examples, V2X communication may be implemented in accordance with the New Radio (NR) cellular V2X standard defined by 5GPP, Release 16, or other suitable standard.

V2X communication enables vehicles 502 and 504 to obtain information related to the weather, nearby accidents, road conditions, activities of nearby vehicles and pedestrians, objects nearby the vehicle, and other pertinent information that may be utilized to improve the vehicle driving experience and increase vehicle safety. For example, such V2X data may enable autonomous driving and improve road safety and traffic efficiency. For example, the exchanged V2X data may be utilized by a V2X connected vehicle 502 and 504 to provide in-vehicle collision warnings, road hazard warnings, approaching emergency vehicle warnings, pre-/post-crash warnings and information, emergency brake warnings, traffic jam ahead warnings, lane change warnings, intelligent navigation services, and other similar information. In addition, V2X data received by a V2X connected mobile device of a pedestrian/cyclist 508 may be utilized to trigger a warning sound, vibration, flashing light, etc., in case of imminent danger.

The sidelink communication between vehicle-UEs (V-UEs) 502 and 504 or between a V-UE 502 or 504 and either an RSU 506 or a pedestrian-UE (P-UE) 508 may occur over a sidelink 512 utilizing a proximity service (ProSe) PC5 interface. In various aspects of the disclosure, the PC5 interface may further be utilized to support D2D sidelink 512 communication in other proximity use cases (e.g., other than V2X). Examples of other proximity use cases may include smart wearables, public safety, or commercial (e.g., entertainment, education, office, medical, and/or interactive) based proximity services. In the example shown in FIG. 5, ProSe communication may further occur between UEs 514 and 516. In some examples, UEs 514 and 516 may be internet-of-things (IoT) devices.

ProSe communication may support different operational scenarios, such as in-coverage, out-of-coverage, and partial coverage. Out-of-coverage refers to a scenario in which UEs (e.g., UEs 514 and 516) are outside of the coverage area of a base station (e.g., base station 510), but each are still configured for ProSe communication. Partial coverage refers to a scenario in which some of the UEs (e.g., V-UE 504) are outside of the coverage area of the base station 510, while other UEs (e.g., V-UE 502 and P-UE 508) are in communication with the base station 510. In-coverage refers to a scenario in which UEs (e.g., V-UE 502 and P-UE 508) are in communication with the base station 510 (e.g., gNB) via a Uu (e.g., cellular interface) connection to receive ProSe service authorization and provisioning information to support ProSe operations.

To facilitate D2D sidelink communication between, for example, UEs 514 and 516 over the sidelink 512, the UEs 514 and 516 may transmit discovery signals therebetween. In some examples, each discovery signal may include a synchronization signal, such as a primary synchronization signal (PSS) and/or a secondary synchronization signal (SSS) that facilitates device discovery and enables synchronization of communication on the sidelink 512. For example, the discovery signal may be utilized by the UE 516 to measure the signal strength and channel status of a potential sidelink (e.g., sidelink 512) with another UE (e.g., UE 514). The UE 516 may utilize the measurement results to select a UE (e.g., UE 514) for sidelink communication or relay communication.

In 5G NR sidelink, sidelink communication may utilize transmission or reception resource pools. For example, the minimum resource allocation unit in frequency may be a sub-channel (e.g., which may include, for example, 10, 15, 20, 25, 50, 75, or 100 consecutive resource blocks) and the minimum resource allocation unit in time may be one slot. The number of sub-channels in a resource pool may include between one and twenty-seven sub-channels. A radio resource control (RRC) configuration of the resource pools may be either pre-configured (e.g., a factory setting on the UE determined, for example, by sidelink standards or specifications) or configured by a base station (e.g., base station 510).

In addition, there may be two main resource allocation modes of operation for sidelink (e.g., PC5) communications. In a first mode, Mode 1, a base station (e.g., gNB) 510 may allocate resources to sidelink devices (e.g., V2X devices or other sidelink devices) for sidelink communication between the sidelink devices in various manners. For example, the base station 510 may allocate sidelink resources dynamically (e.g., a dynamic grant) to sidelink devices, in response to requests for sidelink resources from the sidelink devices. For example, the base station 510 may schedule the sidelink communication via DCI 5_0. In some examples, the base station 510 may schedule the PSCCH/PSSCH within uplink resources indicated in DCI 5_0. The base station 510 may further activate preconfigured sidelink grants (e.g., configured grants) for sidelink communication among the sidelink devices. In some examples, the base station 510 may activate a configured grant (CG) via RRC signaling. In Mode 1, sidelink feedback may be reported back to the base station 510 by a transmitting sidelink device.

In a second mode, Mode 2, the sidelink devices may autonomously select sidelink resources for sidelink communication therebetween. In some examples, a transmitting sidelink device may perform resource/channel sensing to select resources (e.g., sub-channels) on the sidelink channel that are unoccupied. Signaling on the sidelink is the same between the two modes. Therefore, from a receiver's point of view, there is no difference between the modes.

In some examples, sidelink (e.g., PC5) communication may be scheduled by use of sidelink control information (SCI). SCI may include two SCI stages. Stage 1 sidelink control information (first stage SCI) may be referred to herein as SCI-1. Stage 2 sidelink control information (second stage SCI) may be referred to herein as SCI-2.

SCI-1 may be transmitted on a physical sidelink control channel (PSCCH). SCI-1 may include information for resource allocation of a sidelink resource and for decoding of the second stage of sidelink control information (i.e., SCI-2). For example, SCI-1 may include a physical sidelink shared channel (PSSCH) resource assignment and a resource reservation period (if enabled). SCI-1 may further identify a priority level (e.g., Quality of Service (QOS)) of a PSSCH. For example, ultra-reliable-low-latency communication (URLLC) traffic may have a higher priority than text message traffic (e.g., short message service (SMS) traffic). Additionally, SCI-1 may include a PSSCH demodulation reference signal (DMRS) pattern (if more than one pattern is configured). The DMRS may be used by a receiver for radio channel estimation for demodulation of the associated physical channel. As indicated, SCI-1 may also include information about the SCI-2, for example, SCI-1 may disclose the format of the SCI-2. Here, the format indicates the resource size of SCI-2 (e.g., a number of REs that are allotted for SCI-2), a number of a PSSCH DMRS port(s), and a modulation and coding scheme (MCS) index. In some examples, SCI-1 may use two bits to indicate the SCI-2 format. Thus, in this example, four different SCI-2 formats may be supported. SCI-1 may include other information that is useful for establishing and decoding a PSSCH resource.

SCI-2 may also be transmitted on the PSCCH and may contain information for decoding the PSSCH. According to some aspects, SCI-2 includes a 16-bit layer 1 (L1) destination identifier (ID), an 8-bit L1 source ID, a hybrid automatic repeat request (HARQ) process ID, a new data indicator (NDI), and a redundancy version (RV). For unicast communications, SCI-2 may further include a CSI report trigger. For groupcast communications, SCI-2 may further include a zone identifier and a maximum communication range for NACK. SCI-2 may include other information that is useful for establishing and decoding a PSSCH resource.

In some examples, the SCI (e.g., SCI-1 and/or SCI-2) may further include a resource assignment of retransmission resources reserved for one or more retransmissions of the sidelink transmission (e.g., the sidelink traffic/data). Thus, the SCI may include a respective PSSCH resource reservation and assignment for one or more retransmissions of the PSSCH. For example, the SCI may include a reservation message indicating the PSSCH resource reservation for the initial sidelink transmission (initial PSSCH) and one or more additional PSSCH resource reservations for one or more retransmissions of the PSSCH.

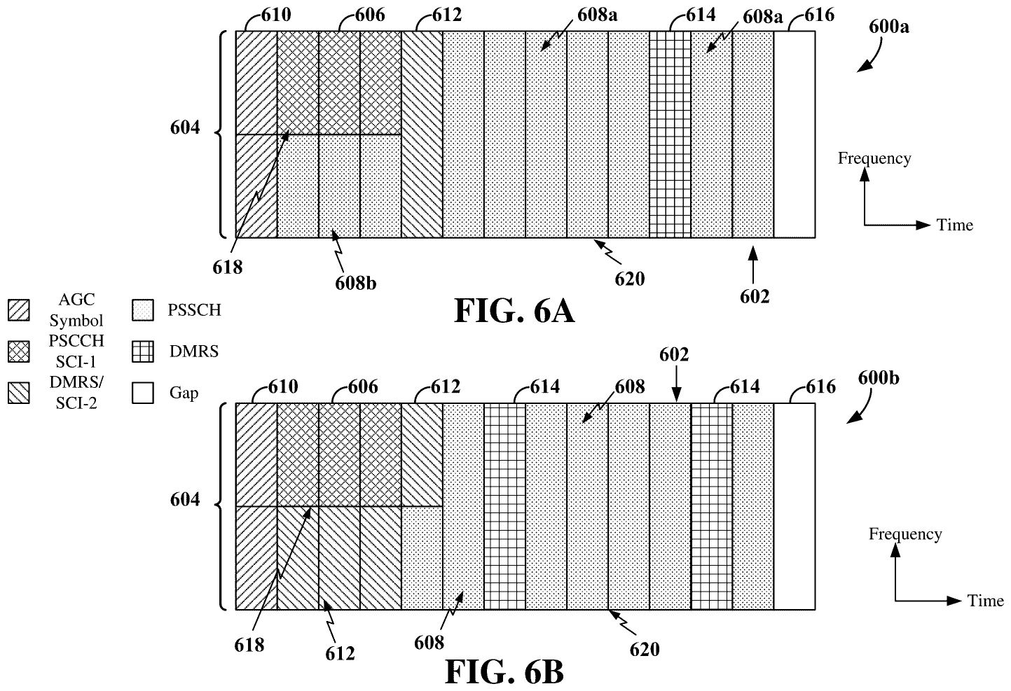

FIG. 6 is a diagram illustrating an example of a sidelink slot structure according to some aspects. The sidelink slot structure may be utilized, for example, in a V2X or other D2D network implementing sidelink. In the example shown in FIG. 6, time is in the horizontal direction with units of symbols 602 (e.g., OFDM symbols); and frequency is in the vertical direction. Here, a carrier bandwidth 604 allocated for sidelink wireless communication is illustrated along the frequency axis. The carrier bandwidth 604 may include a plurality of sub-channels, where each sub-channel may include a configurable number of PRBs (e.g., 10, 15, 20, 25, 50, 75, or 100 PRBs).

FIGS. 6A and 6B are diagrams illustrating examples of sidelink slot structures according to some aspects. The sidelink slot structures may be utilized, for example, in a V2X or other D2D network implementing sidelink. In the examples shown in FIGS. 6A and 6B, time is in the horizontal direction with units of symbols 602 (e.g., OFDM symbols); and frequency is in the vertical direction. Here, a carrier bandwidth 604 allocated for sidelink wireless communication is illustrated along the frequency axis. The carrier bandwidth 604 may include a plurality of sub-channels, where each sub-channel may include a configurable number of PRBs (e.g., 10, 15, 20, 25, 50, 75, or 100 PRBs).

Each of FIGS. 6A and 6B illustrate an example of a respective slot 600a or 600b including fourteen symbols 602 that may be used for sidelink communication. However, it should be understood that sidelink communication can be configured to occupy fewer than fourteen symbols in a slot 600a or 600b, and the disclosure is not limited to any particular number of symbols 602. Each sidelink slot 600a and 600b includes a physical sidelink control channel (PSCCH) 606 occupying a control region 618 of the slot 600a and 600b and a physical sidelink shared channel (PSSCH) 608 occupying a data region 620 of the slot 600a and 600b. The PSCCH 606 and PSSCH 608 are each transmitted on one or more symbols 602 of the slot 600a. The PSCCH 606 includes, for example, SCI-1 that schedules transmission of data traffic on time-frequency resources of the corresponding PSSCH 608. As shown in FIGS. 6A and 6B, the PSCCH 606 and corresponding PSSCH 608 are transmitted in the same slot 600a and 600b. In other examples, the PSCCH 606 may schedule a PSSCH in a subsequent slot.

In some examples, the PSCCH 606 duration is configured to be two or three symbols. In addition, the PSCCH 606 may be configured to span a configurable number of PRBs, limited to a single sub-channel. The PSCCH resource size may be fixed for a resource pool (e.g., 10% to 100% of one sub-channel in the first two or three symbols). For example, the PSCCH 606 may occupy 10, 12, 15, 20, or 25 RBs of a single sub-channel. A DMRS may further be present in every PSCCH symbol. In some examples, the DMRS may be placed on every fourth RE of the PSCCH 606. A frequency domain orthogonal cover code (FD-OCC) may further be applied to the PSCCH DMRS to reduce the impact of colliding PSCCH transmissions on the sidelink channel. For example, a transmitting UE may randomly select the FD-OCC from a set of pre-defined FD-OCCs. In each of the examples shown in FIGS. 6A and 6B, the starting symbol for the PSCCH 606 is the second symbol of the corresponding slot 600a or 600b and the PSCCH 606 spans three symbols 602.

The PSSCH 608 may be time-division multiplexed (TDMed) with the PSCCH 606 and/or frequency-division multiplexed (FDMed) with the PSCCH 606. In the example shown in FIG. 6A, the PSSCH 608 includes a first portion 608a that is TDMed with the PSCCH 606 and a second portion 608b that is FDMed with the PSCCH 606. In the example shown in FIG. 6B, the PSSCH 608 is TDMed with the PSCCH 606.

One and two layer transmissions of the PSSCH 608 may be supported with various modulation orders (e.g., QPSK, 16-QAM, 66-QAM and 256-QAM). In addition, the PSSCH 608 may include DMRSs 614 configured in a two, three, or four symbol DMRS pattern. For example, slot 600a shown in FIG. 6A illustrates a two symbol DMRS pattern, while slot 600b shown in FIG. 6B illustrates a three symbol DMRS pattern. In some examples, the transmitting UE can select the DMRS pattern and indicate the selected DMRS pattern in SCI-1, according to channel conditions. The DMRS pattern may be selected, for example, based on the number of PSSCH 608 symbols in the slot 600a or 600b. In addition, a gap symbol 616 is present after the PSSCH 608 in each slot 600a and 600b.

Each slot 600a and 600b further includes SCI-2 612 mapped to contiguous RBs in the PSSCH 608 starting from the first symbol containing a PSSCH DMRS. In the example shown in FIG. 6A, the first symbol containing a PSSCH DMRS is the fifth symbol occurring immediately after the last symbol carrying the PSCCH 606. Therefore, the SCI-2 612 is mapped to RBs within the fifth symbol. In the example shown in FIG. 6B, the first symbol containing a PSSCH DMRS is the second symbol, which also includes the PSCCH 606. In addition, the SCI-2/PSSCH DMRS 612 are shown spanning symbols two through five. As a result, the SCI-2/PSSCH DMRS 612 may be FDMed with the PSCCH 606 in symbols two through four and TDMed with the PSCCH 606 in symbol five.

The SCI-2 may be scrambled separately from the sidelink shared channel. In addition, the SCI-2 may utilize QPSK. When the PSSCH transmission spans two layers, the SCI-2 modulation symbols may be copied on (e.g., repeated on) both layers. The SCI-1 in the PSCCH 606 may be blind decoded at the receiving wireless communication device. However, since the format, starting location, and number of REs of the SCI-2 612 may be derived from the SCI-1, blind decoding of SCI-2 is not needed at the receiver (receiving UE).

In each of FIGS. 6A and 6B, the second symbol of each slot 600a and 600b is copied onto (repeated on) a first symbol 610 thereof for automatic gain control (AGC) settling. For example, in FIG. 6A, the second symbol containing the PSCCH 606 FDMed with the PSSCH 608b may be transmitted on both the first symbol and the second symbol. In the example shown in FIG. 6B, the second symbol containing the PSCCH 606 FDMed with the SCI-2/PSSCH DMRS 612 may be transmitted on both the first symbol and the second symbol.

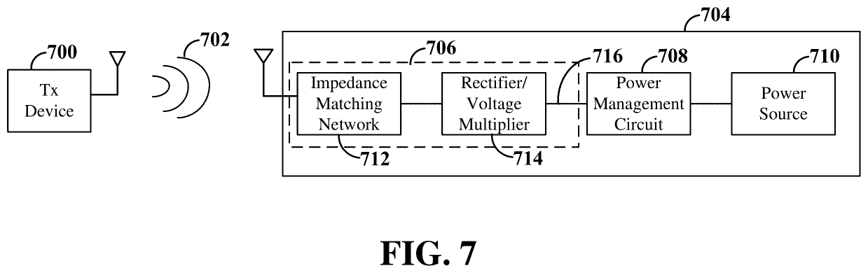

FIG. 7 is a diagram illustrating an example of energy harvesting according to some aspects. In the example shown in FIG. 7, a transmitting (Tx) device 700, such as a base station or wireless communication device (e.g., UE or other sidelink/V2X/IoT device) as shown in FIGS. 1 and/or 5, transmits an RF signal 702 to a receiving (Rx) device 704, such as a wireless communication device (e.g., a UE or other sidelink/V2X/IoT device) as shown in FIGS. 1 and/or 5.

The Rx device 704 includes energy harvesting circuit 706, a power management circuit 708, and a power source 710 (e.g., a battery). The energy harvesting circuit 706 includes an impedance matching network 712 and a rectifier/voltage multiplier 714 configured to receive the RF signal 702 and convert the RF signal 702 into a direct current (DC) signal (e.g., output power) 716. The power management circuit 708 is configured to charge the power source 710 (e.g., store the output power 716 obtained from the energy harvesting circuit 706) or to use the output power 716 immediately to perform one or more data transmission/reception tasks.

Unlike energy harvesting from other sources (e.g., wind, solar, vibrations, etc.), RF energy harvesting (EH) can provide controllable and constant energy transfer over distance. In a fixed RF-EH network, the harvested energy is predictable and relatively stable over time due to a fixed distance between the RF source (e.g., Tx device 700) and the EH device (e.g., Rx device 704). For example, using a random multipath fading model, the energy Eⱼ harvested at receiving node j (e.g., Rx device 704) from a transmitting node i (e.g., Tx device 700) is given by:

$${E}_{j} = η {P}_{i} {\vert {g}_{i - j} \vert}^{2} T , \qquad ( Equation 1 )$$

where Pᵢ is the transmit power by transmitting node i, gᵢ₋ⱼ is the channel coefficient of the link between transmitting node i and receiving node j, T is the time allocated for energy harvesting, and η is the RF-to-DC conversion efficiency and is a function of the input power to the EH circuit.

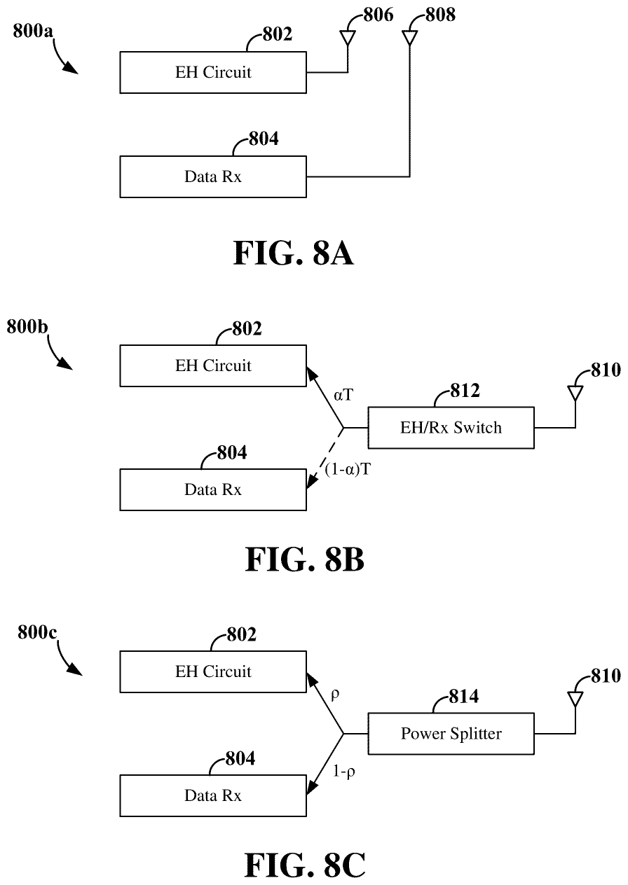

FIGS. 8A, 8B, and 8C are diagrams illustrating examples of energy harvesting receiver architectures 800a, 800b, and 800c, respectively, according to some aspects. Each of the energy harvesting receiver architectures 800a, 800b, and 800c may be implemented, for example, in a receiving device (e.g., a wireless communication, such as a UE or other sidelink/V2X/IoT device), such as the Rx device 704 shown in FIG. 7. In the example shown in FIG. 8A, the energy harvesting receiver architecture 800a is a separated receiver architecture, in which an energy harvesting (EH) circuit 802 is separated from a receiver (e.g., data Rx) 804. In this example, the EH circuit 802 is configured to receive RF signals via a first set of one or more antenna elements 806 (e.g., antenna elements of an antenna array) and the data Rx 804 is configured to receive RF signals via a second set of one or more antenna elements 808. Thus, in the example shown in FIG. 8A, energy harvesting and data reception and processing (e.g., data decoding and processing) can occur simultaneously using the same received RF signal.

In the example shown in FIG. 8B, the energy harvesting receiver architecture 800b is a time-switching architecture in which an EH/Rx switch 812 is configured to receive RF signals via a single set of one or more antenna elements 810. The EH/Rx switch 812 is configured to switch, in time, between the EH circuit 802 and the data Rx 804. Thus, the RF signals received via antenna element(s) 810 may be either energy harvested or decoded based on the EH/Rx switch 812. In this example, the energy harvested at receiver j from source I can be calculated as follows:

$${E}_{j} = η {P}_{i} {\vert {g}_{i - j} \vert}^{2} α T , \qquad ( Equation 2 )$$

where 0≤α≤1 is the fraction of time allocated for energy harvesting. In addition, the data rate can be given by:

$${R}_{i - j} = ( 1 - α ) {log}_{2} ( 1 + \frac{{\vert {g}_{i - j} \vert}^{2} {P}_{i}}{κ W} ) , \qquad ( Equation 3 )$$

where κ is the noise spectral density and W denotes the channel bandwidth.

In the example shown in FIG. 8C, the energy harvesting receiver architecture 800c is a power splitting architecture in which a power splitter 814 is configured to receive RF signals via the single set of one or more antenna elements 810. The power splitter 814 is configured to split the power of the received RF signals between the EH circuit 802 and the data Rx 804. Thus, the RF signals received via antenna element(s) 810 may be simultaneously energy harvested and decoded in a power splitting mode. In this example, the energy harvested at receiver j from source I can be calculated as follows:

$${E}_{j} = ηρ {P}_{i} {\vert {g}_{i - j} \vert}^{2} T , \qquad ( Equation 4 )$$

where 0≤ρ≤1 is the fraction of power allocated for energy harvesting. Thus, ρ represents the power splitting factor used to split the power of a received RF signal between the EH circuit 802 and the data Rx 804. In addition, the data rate in this example can be given by:

$${R}_{i - j} = {log}_{2} ( 1 + \frac{{\vert {g}_{i - j} \vert}^{2} ( 1 - ρ ) {P}_{i}}{κ W} ) . \qquad ( Equation 5 )$$

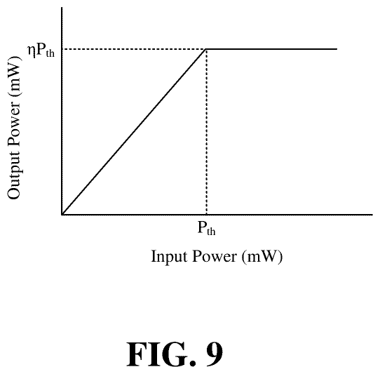

FIG. 9 is a graph illustrating a piece-wise linear energy harvesting model according to some aspects. In the example shown in FIG. 9, the x-axis represents the input power Pᵢₙ to the energy harvesting circuit in mW and the y-axis represents the output power (e.g., harvested energy Eⱼ) of the energy harvesting circuit in mW. The model is linear below a threshold input power (Pₜₕ) and then saturates after the threshold input power. That is, the harvested energy is:

$${E}_{j} = η {P}_{i} {\vert {g}_{i - j} \vert}^{2} T , \qquad ( Equation 1 )$$

if the input power is less than Pₜₕ (i.e., Pᵢ|gᵢ₋ᵢ|²<Pₜₕ). In addition, the harvested energy is:

$${E}_{j} = η {P}_{th} T , \qquad ( Equation 6 )$$

if the input power is greater than or equal to Pₜₕ (i.e., Pᵢ|gᵢ₋ⱼ|²≥Pₜₕ).

Thus, when the input power (Pᵢₙ) exceeds the threshold input power (Pₜₕ), the energy harvested remains the same. Hence, in various aspects of the disclosure, a transmitting device, such as a base station, UE, or other sidelink/V2X/IoT device, can boost the transmit power (Pᵢ) of a transmission (e.g., an RF signal) to increase the input power (Pᵢₙ) to the energy harvesting circuit above the threshold input power (Pₜₕ). A receiving device (e.g., a wireless communication device, such as a UE or other sidelink/V2X/IoT device), can leverage the excess power (e.g., above the Pₜₕ) in decoding (e.g., by increasing the signal-to-noise-plus-interference ratio (SINR) of the data) to optimize performance of data decoding and energy harvesting.

In some examples, the transmitting device can transmit a power boosting parameter indicating the power boosting applied to the transmission (e.g., a downlink transmission or a sidelink transmission) to the receiving device. Based on the power boosting parameter, the receiving device can set the power splitting factor (PSF) (ρ) for concurrent (e.g., simultaneous) data decoding and energy harvesting of the transmission. In some examples, the power boosting parameter may indicate the energy harvesting power boosting of a second portion of a transmission relative to the power of a first portion of the transmission. Thus, the transmission may include a first portion transmitted at a first power and a second portion transmitted at a second power higher than the first power based on the power boosting parameter. The first portion of the transmission may include, for example, control information, whereas the second portion of the transmission may include, for example, data.

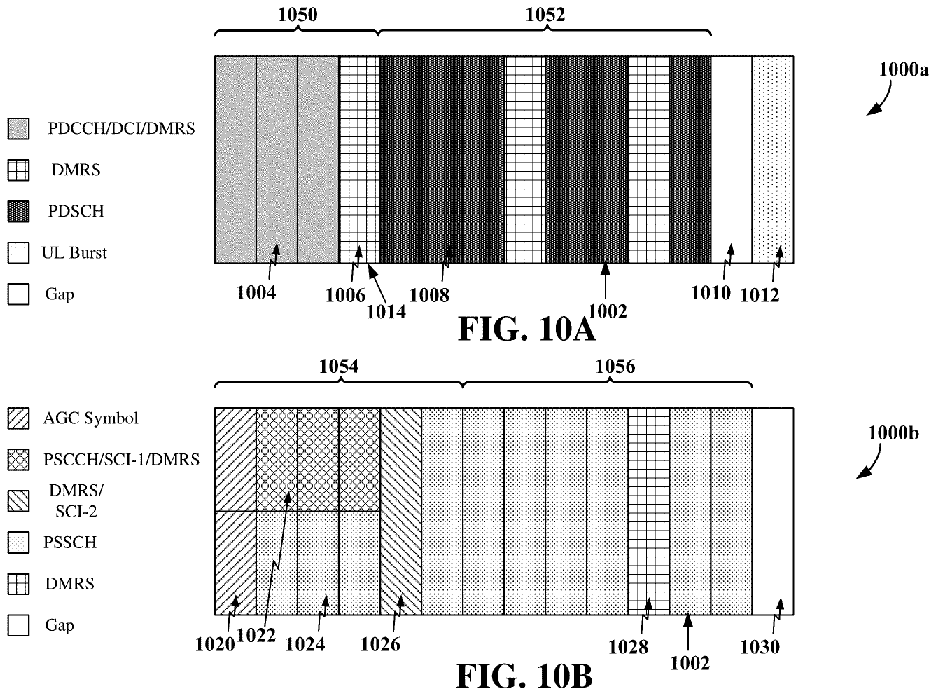

FIGS. 10A and 10B are diagrams illustrating exemplary energy harvesting power boosting of transmissions according to some aspects. FIG. 10A illustrates an exemplary downlink transmission within a slot 1000a, while FIG. 10B illustrates an exemplary sidelink transmission within a slot 1000b. Each slot 1000a and 1000b includes a plurality of symbols 1002. In the examples shown in FIGS. 10A and 10B, each slot 1000a and 1000b includes fourteen symbols. However, it should be understood that sidelink communication can be configured to occupy fewer than fourteen symbols in a slot 1000a or 1000b, and the disclosure is not limited to any particular number of symbols 1002.

Slot 1000a includes a physical downlink control channel (PDCCH) 1004 carrying downlink control information (DCI) within a downlink control region of slot 1000a. In the example shown in FIG. 10A, the downlink control region occupies the first three symbols 1002 of the slot 1000a. The DCI of the PDCCH 1004 is further transmitted with its own DMRS mapped to a portion of the subcarriers within the PDCCH.

Slot 1000a further includes a physical downlink shared channel (PDSCH) 1008 including one or more demodulation reference signals (DMRSs) 1006, each transmitted within one or more DMRS symbols within a data region of the slot 1000a. Here, each DMRS symbol may carry the associated DMRS 1006 mapped to a portion of the subcarriers within the DMRS symbol. Other subcarriers within each DMRS symbol may carry data. In the example shown in FIG. 10A, the data region occupies the next nine symbols 1002 of the slot 1000a. A gap 1010 separates the data region from an uplink burst 1012 within the last symbol 1002 of the slot 1000a. In some examples, the PDSCH 1008 may include a single DMRS symbol mapped to the first, second, or third symbol of the PDSCH 1008. In other examples, the PDSCH 1008 may include a double-symbol DMRS, which may include, for example, the first and second symbols of the PDSCH. In still other examples, the PDSCH 1008 may include a plurality of single-symbol or double-symbol DMRSs, the former being illustrated in FIG. 10A.

Slot 1000b is similar to the slot structure shown in FIG. 6A and includes a physical sidelink control channel (PSCCH) 1022 within a control region of the slot 1000b and a physical sidelink shared channel (PSSCH) 1024 within a data region of the slot 1000b. The PSCCH 1022 includes, for example, SCI-1 that schedules transmission of data traffic on time-frequency resources of the corresponding PSSCH 1024. In addition, the SCI-1 of the PSCCH is further transmitted with its own DMRS mapped to a portion of the subcarriers within the SCI-1. As shown in FIG. 10B, the starting symbol for the PSCCH 1022 is the second symbol of the slot 1000b and the PSCCH 1022 spans three symbols 1002. The PSSCH 1024 includes a first portion that is time-division multiplexed with the PSCCH 1022 and a second portion that is frequency division multiplexed with the PSCCH 1022. In addition, the PSSCH 1024 includes DMRSs 1026 and 1028 configured in a two symbol DMRS pattern. In addition, a gap symbol 1030 is present after the PSSCH 608 in the slot 600.

As shown in FIGS. 6A and 6B, SCI-2 may be mapped to contiguous RBs in the PSSCH 1024 starting from the first symbol containing a PSSCH DMRS. For example, the SCI-2 may be mapped to the fifth symbol occurring immediately after the last symbol carrying the PSCCH 1022. As another example (e.g., as shown in FIG. 6A), the SCI-2 may be mapped to the second through fifth symbols of the slot 1000b. In addition, the second symbol of the slot 1000b is copied onto (repeated on) a first symbol 1020 thereof for automatic gain control (AGC) settling.

In an aspect, the downlink transmission carried within slot 1000a shown in FIG. 10A may include a first portion 1050 transmitted at a first power and a second portion 1052 transmitted at a second power greater than the first power. The first portion includes a set of one or more DMRS symbols. For example, the set of one or more DMRS symbols may include a single-symbol DMRS or double-symbol DMRS of the PDSCH 1008. In other examples, the set of one or more DMRS symbols may include one or more the PDCCH symbols carrying the PDCCH/DCI 1004 and the PDCCH DMRS. In the example shown in FIG. 10A, the first portion 1050 includes the PDCCH/DCI 1004 and a portion of the PDSCH 1008 including the set of one or more DMRS symbols. For example, the first portion 1050 includes a first DMRS 1006 transmitted in a first PDSCH DMRS symbol 1014 of the PDSCH portion of the slot 1000a (e.g., a first DMRS received within the PDSCH 1008). The second portion 1052 includes the remaining symbols of the PDSCH 1008 including the remaining PDSCH DMRSs 1006.

In some examples, a first number of symbols (e.g., X symbols) within the first portion 1050 and a second number of symbols (e.g., Y symbols) within the second portion 1052 may be configured parameters. For example, a transmitting device (e.g., a base station, such as a gNB) may transmit a configuration of X and Y to the receiving wireless communication device (e.g., a UE or other sidelink/V2X/IoT device) via a radio resource control (RRC) message, a medium access control-control element (MAC-CE) or DCI (e.g., PDCCH/DCI 1004 or other DCI). In some examples, the second portion 1052 may begin in a next symbol following a last DMRS symbol of the set of one or more DMRS symbols in the first portion 1050. In other examples, the second portion 1052 may begin after an offset relative to the last DMRS symbol (or the first DMRS symbol) of the set of one or more DMRS symbols in the first portion 1050. In the example shown in FIG. 10A, the second portion 1052 begins in a next symbol following the first DMRS symbol 1014 of the PDSCH 1008.

The transmitting device can further transmit a power boosting parameter to the receiving wireless communication device. The power boosting parameter indicates the power boosting applied to the second portion 1052 of the downlink transmission. The power boosting parameter may be transmitted via, for example, RRC, MAC-CE, or DCI (e.g., PDCCH/DCI 1004 or other DCI). To determine the second power of the second portion 1052 of the downlink transmission, the receiving wireless communication device can measure a reference signal received power (RSRP) of the DMRS 1006 within the first portion 1050 of the downlink transmission. Based on the measured DMRS power (e.g., DMRS RSRP) indicating the first power of the first portion 1050 of the downlink transmission and the power boosting parameter, the receiving wireless communication device can determine the second power of the second portion 1052 of the downlink transmission. The wireless communication device can then select (or adjust) the power splitting factor (PSF) for splitting the second power of the second portion 1052 of the downlink transmission between energy harvesting and data decoding (e.g., decoding of the PDSCH 1008).

Similarly, the sidelink transmission carried within slot 1000b may include a first portion 1054 transmitted at a first power and a second portion 1056 transmitted at a second power greater than the first power. The first portion includes a set of one or more DMRS symbols. For example, the set of one or more DMRS symbols may include at least one SCI-2 symbol carrying a DMRS of the PSSCH 1024 or other PSSCH symbol carrying a DMRS. In other examples, the set of one or more DMRS symbols may include one or more the PSCCH symbols carrying the PSCCH/SCI-1 1022, which may include a PSCCH DMRS. In the example shown in FIG. 10B, the first portion 1054 includes the PSCCH/SCI-1 1022 and a portion of the PSSCH 1024 including the set of one or more DMRS symbols. For example, the first portion 1054 includes a DMRS 1026 transmitted in an SCI-2 symbol of the PSSCH portion of the slot 1000b (e.g., a DMRS received within the SCI-2 of the PSSCH 1024). The second portion 1056 includes the remaining symbols of the PSSCH 1024 including the remaining PSSCH DMRSs 1028.

As in the example shown in FIG. 10A, using the example shown in FIG. 10B, a transmitting device (e.g., a UE or other sidelink/V2X/IoT device) may transmit a configuration of the first portion 1054 and the second portion 1056 (e.g., X and Y) to the receiving wireless communication device (e.g., a UE or other sidelink/V2X/IoT device) via, for example, PC5 (e.g., sidelink) RRC, PC5 MAC-CE or SCI (e.g., SCI-1 or SCI-2 within slot 1000b or another slot). In the example shown in FIG. 10B, the second portion 1056 begins after an offset relative to the SCI-2 DMRS symbol. The offset can include, for example, a configured number of symbols or a portion of a symbol following the SCI-2 DMRS symbol. In the example shown in FIG. 10B, the second portion 1056 begins after an offset of one symbol relative to the SCI-2 DMRS symbol.

The transmitting device can further transmit a power boosting parameter to the receiving wireless communication device. The power boosting parameter indicates the power boosting applied to the second portion 1056 of the sidelink transmission. The power boosting parameter may be transmitted via, for example, PC5 RRC, PC5 MAC-CE, or SCI (e.g., SCI-1 or SCI-2 within slot 1000b or another slot). To determine the second power of the second portion 1056 of the sidelink transmission, the receiving wireless communication device can measure a reference signal received power (RSRP) of the DMRS 1026 within the first portion 1054 of the sidelink transmission. In some examples, the receiving wireless communication device can measure the RSRP of the DMRS within a last DMRS symbol of the first portion 1054. Here, the last DMRS symbol of the first portion 1054 is the SCI-2 DMRS symbol carrying the SCI-2/DMRS 1026 of the slot 1000b (e.g., a first DMRS received within the PSSCH 1024).

Based on the measured DMRS power (e.g., DMRS RSRP) indicating the first power of the first portion 1054 of the sidelink transmission and the power boosting parameter, the receiving wireless communication device can determine the second power of the second portion 1056 of the sidelink transmission. The wireless communication device can then select (or adjust) the power splitting factor (PSF) for splitting the second power of the second portion 1056 of the sidelink transmission between energy harvesting and data decoding (e.g., decoding of the PSSCH 1024).

In some examples, the receiving wireless communication device can further receive a power boosting mode from the transmitting device indicating whether the set of one or more DMRS symbols of the first portion (e.g., portion 1050 or 1054) is within a PDSCH transmission, a DCI transmission, an SCI-1 transmission, or an SCI-2 transmission. The power boosting mode may be received, for example, via an RRC message, MAC-CE, PC5 (sidelink) RRC message, PC5 (sidelink) MAC-CE, DCI, or SCI. In some examples, the power boosting mode may be received in the same DCI/SCI containing the set of one or more DMRS symbols in the first portion (e.g., portion 1050 or 1054). Based on the power boosting mode, the receiving wireless communication device may configure the power boosting and energy harvesting circuitry, as shown in FIGS. 7 and 8.

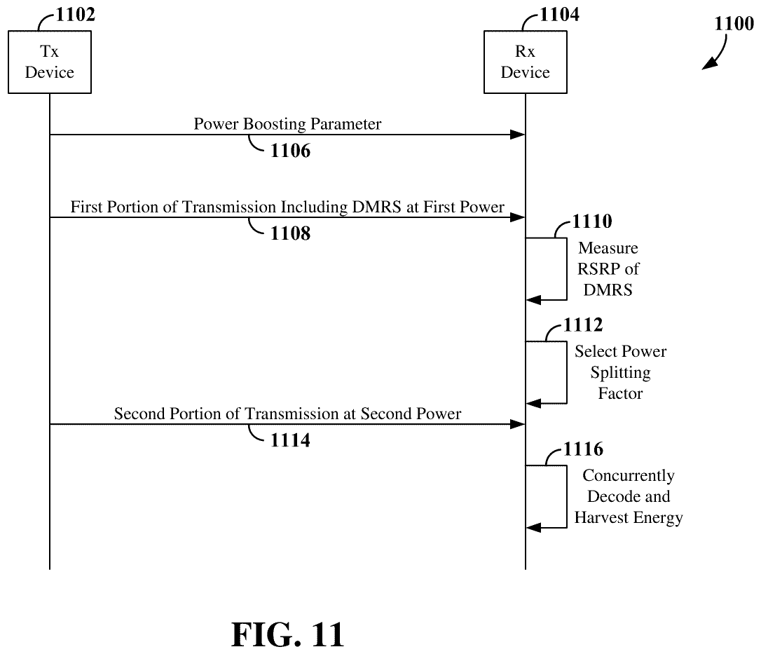

FIG. 11 is a signaling diagram illustrating exemplary signaling 1100 for energy harvesting power boosting of transmissions from a transmitting device (Tx device) 1102 and a receiving device (Rx device) 1104 according to some aspects. The Tx device 1102 may correspond to any of the base stations (e.g., gNBs) or wireless communication devices (e.g., UEs or other sidelink/V2X/IoT devices) shown and described above in connection with FIGS. 1, 5, and/or 7. In addition, the Rx device 1104 may correspond to any of the wireless communication devices (e.g., UEs or other sidelink/V2X/IoT devices) shown and described above in connection with FIGS. 1, 5, 7, and/or 8A-8C.

At 1106, the Tx device 1102 can transmit a message including a power boosting parameter to the Rx device 1104. In some examples, the message includes an RRC message, a MAC-CE, DCI, a PC5 (e.g., sidelink) RRC message, a PC5 MAC-CE, or SCI (e.g., SCI-1 or SCI-2).

At 1108, the Tx device 1102 can transmit a first portion of a transmission (e.g., a downlink transmission or a sidelink transmission) at a first power to the Rx device 1104. The first portion of the transmission can include a set of one or more DMRS symbols. For example, the set of one or more DMRS symbols may include a single-symbol DMRS or double-symbol DMRS of a PDSCH, a DMRS symbol of a PSSCH, or one or more DMRS symbols of DCI or SCI (e.g., SCI-1 or SCI-2). In some examples, the set of one or more DMRS symbols may include a first data symbol immediately after the control symbols of the transmission.

At 1110, the Rx device 1104 can measure the RSRP of the DMRS, and at 1112, select a power splitting factor based on the RSRP of the DMRS and the power boosting parameter. For example, the Rx device 1104 can determine a second power at which a second portion of the transmission will be transmitted based on the DMRS RSRP and the power boosting parameter and then select the power splitting factor for the second power. The power splitting factor (ρ) indicates the fraction of power allocated for energy harvesting. Thus, ρ represents the power splitting factor used to split the power of the second portion of the transmission between energy harvesting and data decoding.

At 1114, the Tx device 1102 can transmit the second portion of the transmission at the second power higher than the first power to the Rx device 1104. In some examples, the second power may be boosted with respect to the first power by the power boosting parameter. Thus, the power boosting parameter indicates the energy harvesting power boosting relative to the DMRS in the first portion of the transmission. The second portion of the transmission may include, for example, a PDSCH or PSSCH.

In some examples, the second portion of the transmission may begin in a next symbol following a last DMRS symbol of the set of one or more DMRS symbols of the first portion of the transmission. In this example, the last DMRS symbol is the last symbol of the first portion of the first transmission. In other examples, the second portion of the transmission may begin after an offset relative to the last DMRS symbol (or first DMRS symbol) of the set of one or more DMRS symbols of the first portion of the transmission. In this example, the offset may include a configured number of symbols or a portion of a symbol following the first/last DMRS symbol in the first portion. In some examples, the number of symbols (X) in the first portion of the transmission and the number of symbols (Y) in the second portion of the transmission may be configured parameters. For example, the Tx device 1102 may transmit the respective number of symbols X and Y in each portion of the transmission via RRC, MAC-CE, DCI, PC5 RRC, PC5 MAC-CE, or SCI. In other examples, the Tx device 1102 can configure the offset relative to the first/last DMRS symbol of the first portion (e.g., the Y symbols begins after K symbols from the first/last DMRS symbol). In this example, the Tx device 1102 may transmit the offset (K) from the first/last DMRS symbol to the Rx device 1104 via RRC, MAC-CE, DCI, PC5 RRC, PC5 MAC-CE, or SCI.

At 1116, the Rx device 1104 can concurrently decode and harvest energy from the second portion of the transmission based on the power boosting parameter. For example, the Rx device 1104 can use the power splitting factor to split the second power of the second portion of the transmission between energy harvesting and data decoding.

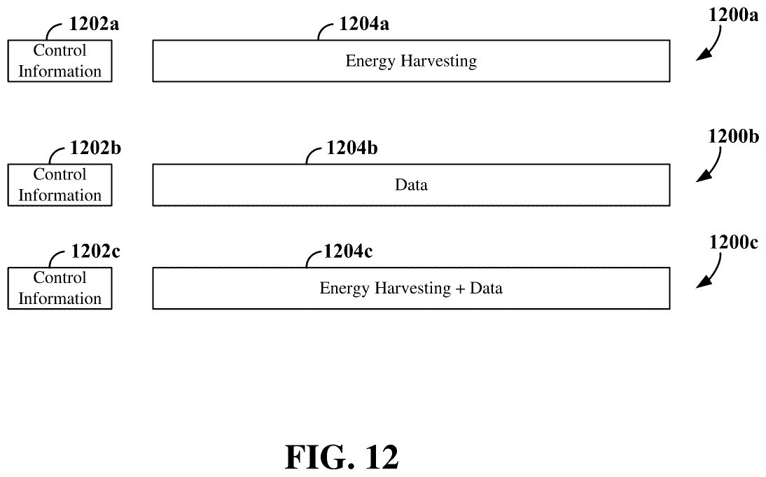

In addition to power boosting for shared data and energy harvesting symbols, various aspects can provide mechanisms to indicate slots that may be used for energy harvesting only, data reception only, or a combination of energy harvesting and data reception using time-switching or power-splitting with or without power boosting. FIG. 12 is a diagram illustrating exemplary slot types according to some aspects. In the example shown in FIG. 12, there are three slots 1200a-1200c illustrated, each including a control portion 1202a-1202c carrying control information (e.g., a PDCCH carrying DCI or a PSCCH carrying SCI) and a data portion 1204a-1204c carrying data (e.g., a PDSCH or PSSCH). In addition, each slot 1200a-1200c corresponds to a respective slot type.

For example, slot 1200a corresponds to an energy harvesting slot type, in which the data portion 1204a of the slot 1200a may be used for energy harvesting. In this example, the PDSCH/PSSCH included in the data portion 1204a may be empty (e.g., including null values). In addition, slot 1200b corresponds to a data slot type, in which the data portion 1204b of the slot 1200b may be used to carry a PDSCH/PSSCH for data decoding. In this example, the data portion 1204b may not be used for energy harvesting. Slot 1200c corresponds to an energy harvesting plus data slot type, in which the data portion 1204c of the slot 1200c may be used to carry a PDSCH/PSSCH for both energy harvesting and data decoding. In some examples, slot 1200c may use time-switching or power-splitting for energy harvesting. In examples in which power-splitting is used, power boosting may also be applied, as described above in connection with FIGS. 10A and 11.

In some examples, the slot type of each slot 1200a-1200c may be indicated via a radio network temporary identifier (RNTI) associated with the control information 1202a-1202c or a CORESET within which the control information 1202a-1202c is located. In some examples, slot-type RNTIs can be generated by the Tx device and used to scramble a cyclic redundancy check (CRC) appended to the PDCCH DCI or PSCCH SCI-1. In other examples, CORESETs (e.g., as shown in FIG. 4) can be defined for specific slot types and used to indicate the slot type associated with a transmission. For example, by including a PDCCH/DCI in a data-only CORESET, the Rx device (e.g., UE) can determine that the PDSCH scheduled by the PDCCH/DCI is a data transmission for decoding only. As another example, by including a PDCCH/DCI in a data plus energy harvesting CORESET, the Rx device can determine that the PDSCH scheduled by the PDCCH/DCI is a data plus energy harvesting transmission for both data decoding and energy harvesting. As still another example, by including a PDCCH/DCI in an energy harvesting-only CORESET, the Rx device can determine that the PDSCH (e.g., an empty PDSCH) scheduled by the PDCCH/DCI is an energy harvesting transmission for energy harvesting only.

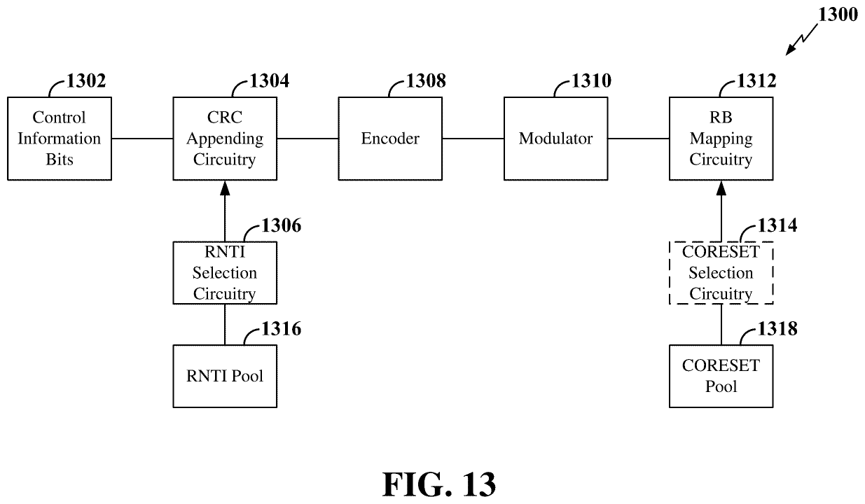

FIG. 13 is a diagram illustrating exemplary circuitry 1300 for generating control information having an RNTI or CORESET indicating a slot type according to some aspects. The circuitry 1300 includes CRC appending circuitry 1304, RNTI selection circuitry 1306, an encoder 1308, a modulator 1310, RB mapping circuitry 1312, and optional CORESET selection circuitry 1314 (e.g., in examples in which the control information is DCI). The CRC appending circuitry 1304 is configured to receive control information bits 1302 and to generate a cyclic redundancy check (CRC) based on the CRC bits 1302. The CRC appending circuitry 1304 is further configured to scramble the CRC with an RNTI and to append the scrambled CRC to the control information bits 1302.

The RNTI utilized by the CRC appending circuitry 1304 to scramble the CRC bits 1302 is selected by the RNTI selection circuitry 1306 from an RNTI pool 1316. In some examples, the RNTI pool 1316 may include slot-type RNTIs, each indicating a specific slot type of a slot within which a data transmission (e.g., a PDSCH or PSSCH) scheduled by the control information (e.g., control information bits 1302) is sent. For example, the RNTI pool 1316 may include a data-only RNTI indicating the slot type is a data reception slot type, an energy harvesting RNTI indicating the slot type is an energy harvesting slot type, and a data plus energy harvesting RNTI indicating the slot type is an energy harvesting and data reception slot type. In some examples, the slot-type RNTIs may be configured via RRC.

The resulting control information including the scrambled CRC bits is input to the encoder 1308 for encoding the control information to produce encoded control information. For example, the encoder 1308 may encode the control information using polar coding. The modulator 1310 is configured to modulate the encoded control information to produce modulated and encoded control information. The RB mapping circuitry 1312 is configured to map the modulated and encoded control information to one or more RBs. In examples in which the control information is DCI, the RB mapping circuitry 1312 may map the modulated and encoded control information to a CORESET selected by the CORESET selection circuitry 1314. The CORESET selection circuitry 1314 may be configured to select the CORESET from a CORESET pool 1318. In some examples, the CORESET pool 1318 includes slot-type CORESETs, each indicating one of the slot types (e.g., data reception slot type, energy harvesting slot type, or energy harvesting and data reception slot type).

Based on the RNTI used to scramble the CRC bits of the control information and/or CORESET within which the control information is located, an Rx device (e.g., a wireless communication device, such as a UE or other sidelink/V2X/IoT device) can determine whether or not the slot scheduled by the control information includes energy harvesting symbols. In some examples, a single DCI can schedule multiple PDSCHs (e.g., multiple slots). In this example, the slot type of each of the scheduled slots can be indicated through various mechanisms.

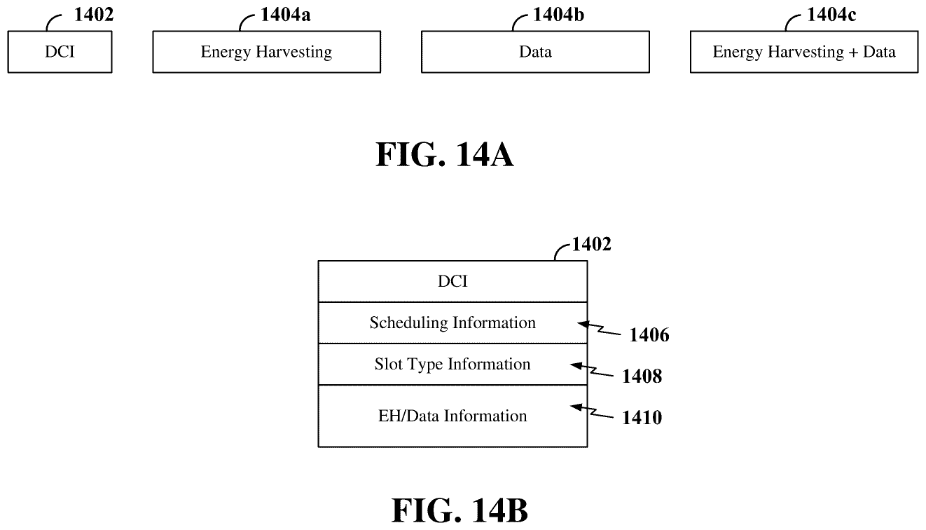

FIG. 14A is a diagram illustrating examples of a single DCI scheduling multiple slots according to some aspects. For example, a single DCI 1402 can schedule PDSCH transmissions in slots 1404a, 1404b, and 1404c. In some examples, slot 1404a may include the DCI 1402. Each slot 1404a-1404c may have a respective slot type. For example, the slot type of slot 1404a may be an energy harvesting slot type, the slot type of slot 1404b may be a data reception slot type, and the slot type of slot 1404c may be an energy harvesting and data reception slot type.

In some examples, the slot type of each of the slots 1404a-1404c may be indicated via an RNTI and/or CORESET used for the DCI 1402. For example, an RNTI and/or CORESET may indicate a time division duplex (TDD) pattern of slot types for the slots 1404a-1404c.

In other examples, the slot types of each of the slots 1404a-1404c may be indicated in the DCI 1402. For example, the DCI 1402 may include a selected TDD pattern of slot types for the slots 1404a-1404c from a plurality of configured slot types. The configured slot types may be previously configured via, for example, RRC signaling or a MAC-CE. For example, the Tx device (e.g., a base station) may transmit a configuration of slot-type TDD patterns (e.g., via an RRC message or MAC-CE) and the DCI 1402 may include a selected one of the slot-type TDD patterns. In other examples, the DCI 1402 may include an explicit indication of the slot type of each of the slots 1404a-1404c. For example, the DCI 1402 may include a bitmap indicating the slot types of each of the slots 1404a-1404c. As another example, the bitmap may be defined via, for example, RRC or MAC-CE, and the DCI 1402 may include a trigger that triggers the predefined bitmap.

In other examples, the slot types of each of the slots 1404a-1404c may be indicated by a combination of RNTI and/or CORESET, along with other slot type information included in the DCI 1402. For example, the RNTI and/or CORESET may indicate the slot type of the first slot 1404a, and the DCI 1402 may include slot type information indicating the slot types of the remaining slots 1404b and 1404c. As another example, the combination of RNTI and/or CORESET and the other slot type information in the DCI 1402 may indicate the respective slot types of all of the slots 1404a-1404c.

FIG. 14B is a diagram illustrating an example of the DCI 1402 scheduling a plurality of slots according to some aspects. The DCI 1402 can include scheduling information 1406 scheduling the multiple PDSCHs within slots 1404a, 1404b, and 1404c. The DCI 1402 can further include slot type information 1408 indicating the slot type of each of the slots 1404a, 1404b, and 1404c. In some examples, the slot type information 1408 includes a bitmap or a trigger for a predefined bitmap (e.g., which may be predefined via RRC or MAC-CE). In other examples, the slot type information 1408 includes a TDD pattern (e.g., a selected TDD pattern from a plurality of configured TDD patterns). The DCI 1402 can further include energy harvesting (EH)/data information 1410. The EH/data information 1410 may include, for example, a respective power splitting factor or time-switching indicator for each of the slots (e.g., slot 1404c) having an energy harvesting and data reception slot type. In addition, the EH/data information 1410 may further include a power boosting parameter for each energy harvesting and data reception slot (e.g., slot 1404c). The EH/data information 1410 may further include a power boosting mode for each energy harvesting and data reception slot type.

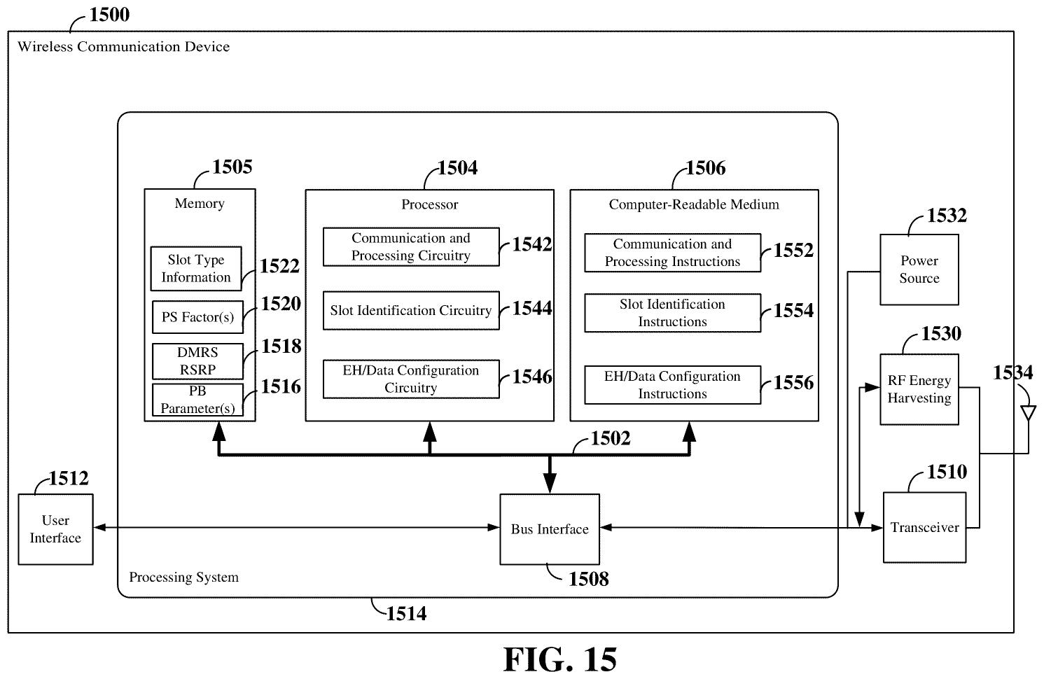

FIG. 15 is a block diagram illustrating an example of a hardware implementation for a wireless communication device 1500 employing a processing system 1514. For example, the wireless communication device 1500 may correspond to a UE or other sidelink/V2X/IoT device, as shown and described above in reference to FIG. 1, 5, 7, 8, 11, or 13.

The wireless communication device 1500 may be implemented with a processing system 1514 that includes one or more processors 1504. Examples of processors 1504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1500 may be configured to perform any one or more of the functions described herein. That is, the processor 1504, as utilized in the wireless communication device 1500, may be used to implement any one or more of the processes and procedures described below.

The processor 1504 may in some instances be implemented via a baseband or modem chip and in other implementations, the processor 1504 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1514 may be implemented with a bus architecture, represented generally by the bus 1502. The bus 1502 may include any number of interconnecting buses and bridges depending on the specific application of the processing system 1514 and the overall design constraints. The bus 1502 links together various circuits including one or more processors (represented generally by the processor 1504), a memory 1505, and computer-readable media (represented generally by the computer-readable medium 1506). The bus 1502 may also link various other circuits such as timing sources, peripherals, voltage regulators, and power management circuits, which are well known in the art, and therefore, will not be described any further.

A bus interface 1508 provides an interface between the bus 1502, a transceiver 1510, an RF energy harvesting circuit 1530, and a power source 1532. The transceiver 1510 provides a means for communicating with various other apparatus over a transmission medium (e.g., air interface) via at least one antenna 1534 (e.g., at least one antenna array). The RF energy harvesting circuit 1530 provides a means for harvesting energy from RF signals (e.g., received transmissions) received via the at least one antenna 1534. The power source 1532 provides a means for supplying power to various components in the wireless communication device 1500 and may be charged by the RF energy harvesting circuit 1530. Depending upon the nature of the apparatus, a user interface 1512 (e.g., keypad, display, touch screen, speaker, microphone, control knobs, etc.) may also be provided. Of course, such a user interface 1512 is optional, and may be omitted in some examples.

The processor 1504 is responsible for managing the bus 1502 and general processing, including the execution of software stored on the computer-readable medium 1506. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 1504, causes the processing system 1514 to perform the various functions described below for any particular apparatus. The computer-readable medium 1506 and the memory 1505 may also be used for storing data that is manipulated by the processor 1504 when executing software. For example, the memory 1505 may store one or more of power boosting (PB) parameter(s) 1516, a measured demodulation reference signal (DMRS) reference signal received power (RSRP) 1518, power splitting (PS) factor(s) 1520, and slot-type information 1522, which may be used by the processor 1504 in processing slots for data decoding and/or energy harvesting. In some examples, the slot-type information 1522 may include, for example, a list of RNTIs and/or CORESETs, each associated with a respective slot type of a plurality of slot types. In other examples, the slot-type information 1522 may include a specific indication of a slot type of a slot or a time division duplex (TDD) pattern or bitmap indicating a respective slot type of a plurality of slots.

The computer-readable medium 1506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1506 may reside in the processing system 1514, external to the processing system 1514, or distributed across multiple entities including the processing system 1514. The computer-readable medium 1506 may be embodied in a computer program product. By way of example, a computer program product may include a computer-readable medium in packaging materials. In some examples, the computer-readable medium 1506 may be part of the memory 1505. Those skilled in the art will recognize how best to implement the described functionality presented throughout this disclosure depending on the particular application and the overall design constraints imposed on the overall system.

In some aspects of the disclosure, the processor 1504 may include circuitry configured for various functions. For example, the processor 1504 may include communication and processing circuitry 1542, configured to communicate with one or more sidelink devices (e.g., other UEs, such as V2X devices) via respective sidelinks (e.g., PC5 interfaces). In addition, the communication and processing circuitry 1542 may be configured to communicate with a network access node (e.g., a base station, such as a gNB or eNB) via a Uu link. In some examples, the communication and processing circuitry 1542 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1542 may include one or more transmit/receive chains.

In some implementations where the communication involves receiving information, the communication and processing circuitry 1542 may obtain information from a component of the wireless communication device 1500 (e.g., from the transceiver 1510 that receives the information via radio frequency signaling or some other type of signaling suitable for the applicable communication medium), process (e.g., decode) the information, and output the processed information. For example, the communication and processing circuitry 1542 may output the information to another component of the processor 1504, to the memory 1505, or to the bus interface 1508. In some examples, the communication and processing circuitry 1542 may receive one or more of signals, messages, other information, or any combination thereof. In some examples, the communication and processing circuitry 1542 may receive information via one or more channels. In some examples, the communication and processing circuitry 1542 may include functionality for a means for receiving. In some examples, the communication and processing circuitry 1542 may include functionality for a means for processing, including a means for demodulating, a means for decoding, etc.

In some implementations where the communication involves sending (e.g., transmitting) information, the communication and processing circuitry 1542 may obtain information (e.g., from another component of the processor 1504, the memory 1505, or the bus interface 1508), process (e.g., modulate, encode, etc.) the information, and output the processed information. For example, the communication and processing circuitry 1542 may output the information to the transceiver 1510 (e.g., that transmits the information via radio frequency signaling or some other type of signaling suitable for the applicable communication medium). In some examples, the communication and processing circuitry 1542 may send one or more of signals, messages, other information, or any combination thereof. In some examples, the communication and processing circuitry 1542 may send information via one or more channels. In some examples, the communication and processing circuitry 1542 may include functionality for a means for sending (e.g., a means for transmitting). In some examples, the communication and processing circuitry 1542 may include functionality for a means for generating, including a means for modulating, a means for encoding, etc.

The communication and processing circuitry 1542 may be configured to receive, via the transceiver 1510, a message including the PB parameter 1516 indicating a power boosting amount for energy harvesting of a transmission (e.g., downlink transmission or sidelink transmission) from a transmitting device (e.g., a base station or another wireless communication device, such as a UE or other sidelink/V2X/IoT device). In some examples, the message may include DCI, SCI, an RRC or sidelink RRC message or a MAC-CE or sidelink MAC-CE. In some examples, the communication and processing circuitry 1542 may be configured to receive DCI scheduling a plurality of transmissions. In this example, the DCI may include a respective PB parameter 1516 for two or more of the scheduled transmissions. In some examples, the DCI may further include a respective slot type associated with each of the scheduled transmissions. For example, the slot types may include one or more of an energy harvesting slot type, an energy harvesting and data reception slot type, or a data reception slot type.

The communication and processing circuitry 1542 may be configured to receive a first portion of the transmission at a first power. In some examples, the first portion of the transmission may include a DMRS within a set of one or more DMRS symbols of the transmission. The set of one or more DMRS symbols may include, for example, at least a first DMRS symbol within a PDSCH transmission, a PSSCH transmission, or SCI-2, or may include one or more DMRS symbols within DCI or SCI-1. The communication and processing circuitry 1542 may further be configured to receive a power boosting mode indicating whether the set of one or more symbols is within a PDSCH transmission, a DCI transmission, an SCI-1 transmission, or an SCI-2 transmission. The communication and processing circuitry 1542 may further be configured to receive a second portion of the transmission at a second power higher than the first power. The communication and processing circuitry 1542 may further be configured to decode the second portion of the transmission.

In some examples, the second portion of the transmission begins in a next symbol following a last DMRS symbol of the set of one or more DMRS symbols of the first portion of the transmission. In other examples, the second portion begins after an offset relative to the last DMRS symbol (or first DMRS symbol) of the set of one or more DMRS symbols of the first portion of the transmission. For example, the offset can include a number of symbols of a portion of a symbol following the last DMRS symbol. In some examples, the communication and processing circuitry 1542 may further be configured to receive a configuration of the first portion of the transmission and the second portion of the transmission via an RRC message, a sidelink RRC message, a MAC-CE, a sidelink MAC-CE, or control information (e.g., DCI or SCI). For example, the configuration may include a number of symbols in the first portion of the transmission and a number of symbols in the second portion of the transmission. In other examples, the configuration may indicate the offset from the first/last DMRS symbol in the first portion of the transmission.

In some examples, the communication and processing circuitry 1542 may further be configured to receive control information associated with the transmission within a slot. The control information may be associated with the slot-type information 1522. For example, the control information may be at least one of scrambled with an RNTI or located within a CORESET indicating that the slot is an energy harvesting slot that further carries data associated with the transmission. The control information may include, for example, DCI or SCI.

In some examples, the communication and processing circuitry 1542 may be configured to receive control information (e.g., DCI or SCI) within a first portion of a slot. The control information may be associated with the slot-type information 1522. For example, the control information may be at least one of located within a CORESET or scrambled with an RNTI indicating a slot type of the slot. The slot type may include an energy harvesting slot type, an energy harvesting and data reception slot type, or a data reception slot type. In some examples, the communication and processing circuitry 1542 may further be configured to receive a configuration of a plurality of RNTIs, each associated with a respective slot type of a plurality of slot types.

In some examples, the control information may further include scheduling information scheduling a plurality of slots including the slot. In this example, at least one of the CORESET or the RNTI may indicate a respective slot type of each of the plurality of slots based on the slot-type information 1522. In other examples, the control information further includes the slot-type information 1522 indicating the respective slot type of each of the plurality of slots. For example, the slot-type information 1522 may include a slot-type TDD pattern or a bitmap indicating the respective slot type of each of the plurality of slots. In some examples, the communication and processing circuitry 1542 may further be configured to receive a configuration of a plurality of slot-type TDD patterns including the slot-type TDD pattern.

The communication and processing circuitry 1542 may further be configured to receive a second portion of the slot based on the slot type. For example, the communication and processing circuitry 1542 may be configured to decode the second portion of the slot based on the slot type being the data reception slot type or the energy harvesting and data reception slot type. In examples in which the slot type is the energy harvesting and data reception slot type, the communication and processing circuitry 1542 may further be configured to receive the PB parameter 1516 indicating a power boosting amount for energy harvesting. The communication and processing circuitry 1542 may further be configured to execute communication and processing instructions (software) 1552 stored in the computer-readable medium 1506 to implement one or more of the functions described herein.

The processor 1504 may further include slot identification circuitry 1544, configured to identify a slot type of one or more slots based on the slot-type information 1522. For example, the slot identification circuitry 1544 may be configured to identify the slot type of the slot within which the control information is received. In this example, the slot identification may be configured to identify the slot type of the slot based on the slot-type information 1522 associated with the control information. For example, the control information may specifically include the slot-type information 1522 (e.g., a specific indication of the slot type of the slot). As another example, the control information may be at least one of scrambled with an RNTI or located within a CORESET that indicates the slot type based on the slot-type information 1522.

In examples in which the control information schedules a plurality of slots, the slot identification circuitry 1544 may be configured to identify the slot type of each of the plurality of slots based on the RNTI and/or CORESET and/or slot-type information 1522 included within the control information. For example, the slot-type information 1522 included within the control information may include a TDD pattern or bitmap indicating the slot type of each of the plurality of slots. The slot identification circuitry 1544 may further be configured to execute slot identification instructions (software) 1554 stored in the computer-readable medium 1506 to implement one or more of the functions described herein.

The processor 1504 may further include energy harvesting (EH)/data configuration circuitry 1546, configured to select at least one of energy harvesting or data decoding for a transmission received within a slot. For example, the EH/data configuration circuitry 1546 may be configured to select energy harvesting and/or data decoding based on a slot type of the slot. In some examples, the EH/data configuration circuitry 1546 may be configured to select data decoding only in response to the slot type of the slot being a data reception slot type. In this example, the EH/data configuration circuitry 1546 may be configured to instruct the communication and processing circuitry 1542 to decode the received transmission.

In other examples, the EH/data configuration circuitry 1546 may be configured to select energy harvesting only in response to the slot type of the slot being an energy harvesting slot. In this example, the EH/data configuration circuitry 1546 may be configured to instruct the RF energy harvesting circuit 1530 to harvest energy from the transmission received within the slot. The RF energy harvesting circuit 1530 may further charge the power source 1532 or provide the harvested energy to other components of the wireless communication device 1500 for performing one or more tasks.

In other examples, the EH/data configuration circuitry 1546 may be configured to select both energy harvesting and data decoding in response to the slot type of the slot being an energy harvesting and data reception slot. In this example, the EH/data configuration circuitry 1546 may further be configured to either time-split the transmission between the RF energy harvesting circuit 1530 and the transceiver 1510/communication and processing circuitry 1542 using a time-splitter (e.g., as shown in FIG. 8B), or to concurrently enable both data decoding and energy harvesting. For example, the wireless communication device 1500 may include separate antennas 1534 for the transceiver 1510 and the RF energy harvesting circuit 1530 to facilitate independent energy harvesting and data reception of the same transmission. As another example, the EH/data configuration circuitry 1546 may be configured to power-split the transmission between the RF energy harvesting circuit 1530 and the transceiver 1510/communication and processing circuitry 1542 using a power-splitter (e.g., as shown in FIG. 8C).

In examples in which power-splitting is performed, the EH/data configuration circuitry 1546 may be configured to select the PS factor 1520 and use the PS factor 1520 to split the power from the received transmission between the energy harvesting circuit 1530 and the communication and processing circuitry 1542. In some examples, the EH/data configuration circuitry 1546 may be configured to select the PS factor 1520 based on the PB parameter 1516. For example, the EH/data configuration circuitry 1546 may be configured to measure the DMRS RSRP 1518 of the DMRS within the set of one or more DMRS symbols of the transmission (e.g., within the first portion of the transmission) and to select the PS factor 1520 based on the DMRS RSRP 1518 and the PB parameter.

In examples in which DCI schedules a plurality of slots, the EH/data configuration circuitry 1546 may be configured to select the PS factor 1520 for each of the plurality of slots (e.g., for each of the slots that has an energy harvesting and data reception slot type) based on a single PB parameter 1516 applicable to all of the slots or a respective PB parameter 1516 for each of the slots. The EH/data configuration circuitry 1546 may further be configured to execute E/H data configuration instructions (software) 1556 stored in the computer-readable medium 1506 to implement one or more of the functions described herein.

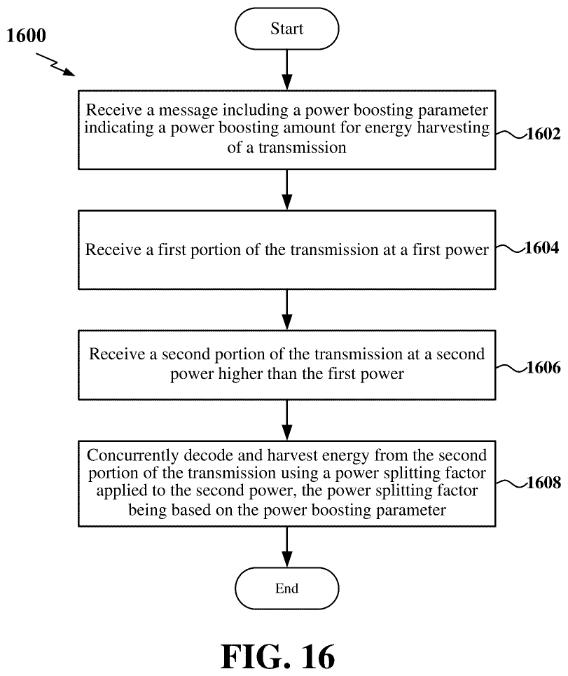

FIG. 16 is a flow chart of an exemplary method 1600 for power boosting for shared data and energy harvesting symbols according to some aspects. As described below, some or all illustrated features may be omitted in a particular implementation within the scope of the present disclosure, and some illustrated features may not be required for implementation of all examples. In some examples, the method may be performed by the wireless communication device 1500, as described above and illustrated in FIG. 15, by a processor or processing system, or by any suitable means for carrying out the described functions.

At block 1602, the wireless communication device (e.g., a UE or other sidelink/V2X/IoT device) may receive a message including a power boosting parameter indicating a power boosting amount for energy harvesting of a transmission. In some examples, the message may include downlink control information, a radio resource control message, or a medium access control-control element. In other examples, the message may include sidelink control information, a sidelink radio resource control message, or a sidelink medium access control-control element. For example, the communication and processing circuitry 1542, together with the transceiver 1510 and antenna 1534, shown and described above in connection with FIG. 15, may provide a means to receive the message including the power boosting parameter.

At block 1604, the wireless communication device may receive a first portion of the transmission at a first power. In some examples, the wireless communication device may receive a demodulation reference signal (DMRS) within a set of one or more DMRS symbols of the first portion of the transmission. In some examples, the set of one or more DMRS symbols includes at least a first DMRS symbol within a physical downlink shared channel (PDSCH) transmission, a physical sidelink shared channel (PSSCH) transmission, or a SCI-2 transmission. In other examples, the set of one or more DMRS symbols is within a downlink control information (DCI) transmission or a first stage sidelink control information (SCI-1) transmission. In some examples, the wireless communication device may further receive a power boosting mode indicating whether the set of one or more DMRS symbols is within a physical downlink shared channel (PDSCH) transmission, a physical sidelink shared channel (PSSCH) transmission, a downlink control information (DCI) transmission, a first stage sidelink control information (SCI-1) transmission, or a second stage SCI (SCI-2) transmission. For example, the communication and processing circuitry 1542, together with the transceiver 1510 and antenna 1534, shown and described above in connection with FIG. 15 may provide a means to receive the first portion of the transmission.

At block 1606, the wireless communication device may receive a second portion of the transmission at a second power higher than the first power. In some examples, the second portion of the transmission begins in a next symbol following a last DMRS symbol of the set of one or more DMRS symbols. In other examples, the second portion of the transmission begins after an offset relative to the last DMRS symbol of the set of one or more DMRS symbols. The offset can include a number of symbols or a portion of a symbol following the last DMRS symbol. In some examples, the wireless communication device may further receive a configuration of the first portion of the transmission and the second portion of the transmission via a radio resource control message, a medium access control-control element, a sidelink radio resource control message, a sidelink medium access control-control element, or control information. For example, the RF energy harvesting circuit 1530, together with the communication and processing circuitry 1542, transceiver 1510, and antenna 1534 shown and described above in connection with FIG. 15 may provide a means to receive the second portion of the transmission.

At block 1608, the wireless communication device may concurrently decode and harvest energy from the second portion of the transmission using a power splitting factor applied to the second power, where the power splitting factor is based on the power boosting parameter. In some examples, the wireless communication device may measure a reference signal received power (RSRP) of the DMRS and select the power splitting factor based on the RSRP of the DMRS and the power boosting parameter.

In some examples, the wireless communication device may receive control information associated with the transmission within a slot, where the control information is at least one of scrambled with a radio network temporary identifier (RNTI) or located within a control resource set (CORESET) indicating the slot is an energy harvesting slot that further carries data associated with the transmission. In some examples, the control information may include downlink control information or sidelink control information.

In some examples, the message may include control information scheduling a plurality of transmissions including the transmission. In this example, the wireless communication device may select a respective power splitting factor for at least two of the plurality of transmissions based on the power boosting parameter. In other examples, the control information includes a respective power boosting parameter for at least two of the plurality of transmissions, and the wireless communication device may select a respective power splitting factor for the at least two of the plurality of transmissions based on the respective power boosting parameter. In some examples, the control information further indicates a respective slot type associated with each of the plurality of transmissions, where the respective slot type includes an energy harvesting slot type, an energy harvesting and data reception slot type, or a data reception slot type. For example, the EH/data configuration circuitry 1546, together with the RF energy harvesting circuit 1530 and the communication and processing circuitry 1542 shown and described above in connection with FIG. 15 may provide a means to concurrently decode and harvest energy from the second portion of the transmission using the power splitting factor.

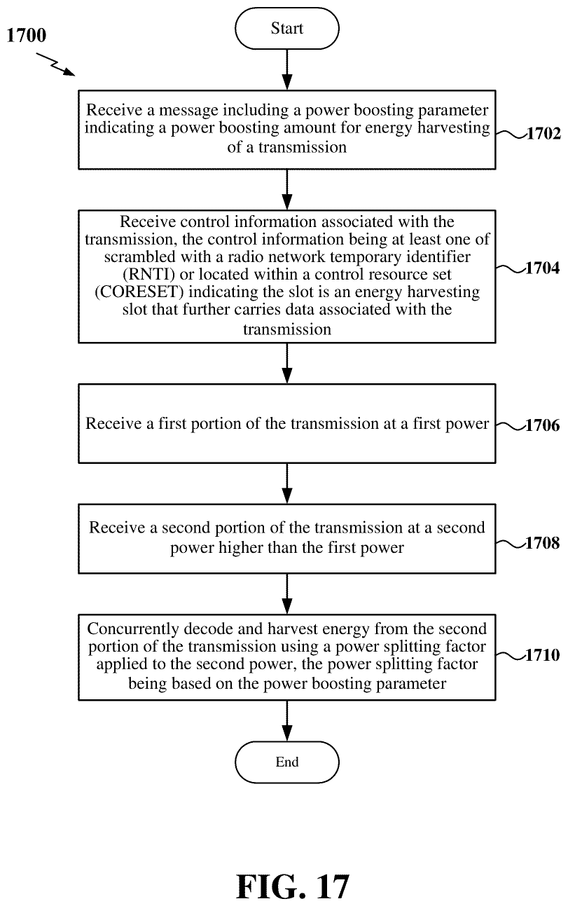

FIG. 17 is a flow chart of another exemplary method 1700 for power boosting for shared data and energy harvesting symbols according to some aspects. As described below, some or all illustrated features may be omitted in a particular implementation within the scope of the present disclosure, and some illustrated features may not be required for implementation of all examples. In some examples, the method may be performed by the wireless communication device 1500, as described above and illustrated in FIG. 15, by a processor or processing system, or by any suitable means for carrying out the described functions.

At block 1702, the wireless communication device (e.g., a UE or other sidelink/V2X/IoT device) may receive a message including a power boosting parameter indicating a power boosting amount for energy harvesting of a transmission. In some examples, the message may include downlink control information, a radio resource control message, or a medium access control-control element. In other examples, the message may include sidelink control information, a sidelink radio resource control message, or a sidelink medium access control-control element. For example, the communication and processing circuitry 1542, together with the transceiver 1510 and antenna 1534, shown and described above in connection with FIG. 15, may provide a means to receive the message including the power boosting parameter.

At block 1704, the wireless communication device may receive control information associated with the transmission, where the control information is at least one of scrambled with a radio network temporary identifier (RNTI) or located within a control resource set (CORESET) indicating the slot is an energy harvesting slot that further carries data associated with the transmission. In some examples, the control information may be the message that includes the power boosting parameter. In some examples, the control information may include downlink control information or sidelink control information. In examples in which the control information is sidelink control information, the control information may be scrambled with the RNTI. In examples in which the control information is downlink control information, the control information may be scrambled with the RNTI and/or located within the CORESET. For example, the slot identification circuitry 1544, together with the communication and processing circuitry 1542, transceiver 1510, and antenna 1534 shown and described above in connection with FIG. 15 may provide a means to receive the control information.

At block 1706, the wireless communication device may receive a first portion of the transmission at a first power. In some examples, the wireless communication device may receive a demodulation reference signal (DMRS) within a set of one or more DMRS symbols of the first portion of the transmission. In some examples, the set of one or more DMRS symbols includes at least a a first DMRS symbol within a physical downlink shared channel (PDSCH) transmission, physical sidelink shared channel (PSSCH) transmission, or a SCI-2 transmission. In other examples, the set of one or more DMRS symbols is within a downlink control information (DCI) transmission or a first stage sidelink control information (SCI-1) transmission. For example, the communication and processing circuitry 1542, together with the transceiver 1510 and antenna 1534, shown and described above in connection with FIG. 15 may provide a means to receive the first portion of the transmission.

At block 1708, the wireless communication device may receive a second portion of the transmission at a second power. In some examples, the second portion of the transmission begins in a next symbol following a last symbol of the set of one or more DMRS symbols. In other examples, the second portion of the transmission begins after an offset relative to the last DMRS symbol of the set of one or more DMRS symbols. The offset can include a number of symbols or a portion of a symbol following the last DMRS symbol. In some examples, the wireless communication device may further receive a configuration of the first portion of the transmission and the second portion of the transmission via a radio resource control message, a medium access control-control element, a sidelink radio resource control message, a sidelink medium access control-control element, or control information. For example, the RF energy harvesting circuit 1530, together with the communication and processing circuitry 1542, transceiver 1510, and antenna 1534 shown and described above in connection with FIG. 15 may provide a means to receive the second portion of the transmission.

At block 1710, the wireless communication device may concurrently decode and harvest energy from the second portion of the transmission using a power splitting factor applied to the second power, where the power splitting factor is based on the power boosting parameter. In some examples, the wireless communication device may measure a reference signal received power (RSRP) of the DMRS and select the power splitting factor based on the RSRP of the DMRS and the power boosting parameter. For example, the EH/data configuration circuitry 1546, together with the RF energy harvesting circuit 1530 and the communication and processing circuitry 1542 shown and described above in connection with FIG. 15 may provide a means to concurrently decode and harvest energy from the second portion of the transmission using the power splitting factor.

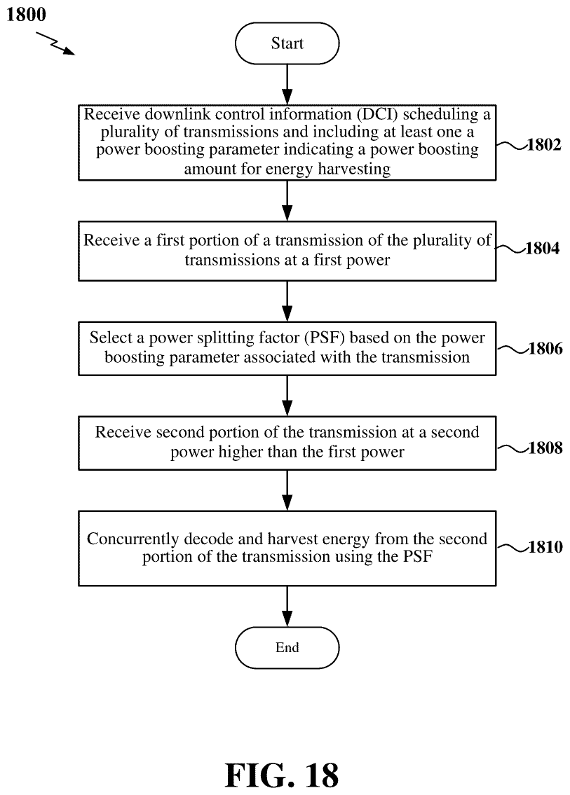

FIG. 18 is a flow chart of another exemplary method 1800 for power boosting for shared data and energy harvesting symbols according to some aspects. As described below, some or all illustrated features may be omitted in a particular implementation within the scope of the present disclosure, and some illustrated features may not be required for implementation of all examples. In some examples, the method may be performed by the wireless communication device 1500, as described above and illustrated in FIG. 15, by a processor or processing system, or by any suitable means for carrying out the described functions.

At block 1802, the wireless communication device (e.g., a UE or other sidelink/V2X/IoT device) may receive a downlink control information (DCI) scheduling a plurality of transmissions and including at least one of a power boosting parameter indicating a power boosting amount for energy harvesting. In some examples, the DCI may include a single power boosting parameter applicable to all of the transmissions having shared data and energy harvesting symbols. In other examples, the DCI includes a respective power boosting parameter for at least two of the plurality of transmissions (e.g., each of the transmissions having shared data and energy harvesting symbols).

In some examples, the control information further indicates a respective slot type associated with each of the plurality of transmissions, where the respective slot type includes an energy harvesting slot type, an energy harvesting and data reception slot type, or a data reception slot type. For example, the control information may be at least one of scrambled with a radio network temporary identifier (RNTI) or located within a control resource set (CORESET) indicating the respective slot type of each of the plurality of transmissions. In other examples, the control information may include slot type information (e.g., a TDD pattern or bitmap) indicating the respective slot type of each of the plurality of transmissions. In other examples, a combination of the RNTI and/or CORESET together with the slot type information included in the DCI may indicate the respective slot type associated with each of the plurality of transmissions. For example, the communication and processing circuitry 1542, together with the transceiver 1510 and antenna 1534, shown and described above in connection with FIG. 15, may provide a means to receive the DCI.

At block 1804, the wireless communication device may receive a first portion of a transmission of the plurality of transmissions at a first power. In some examples, the wireless communication device may receive a demodulation reference signal (DMRS) within a set of one or more DMRS symbols of the first portion of the transmission. In some examples, the set of one or more DMRS symbols includes at least a first DMRS symbol within a physical downlink shared channel (PDSCH) transmission, a physical sidelink shared channel (PSSCH) transmission, or a SCI-2 transmission. In other examples, the set of one or more DMRS symbols is within a downlink control information (DCI) transmission or a first stage sidelink control information (SCI-1) transmission. For example, the communication and processing circuitry 1542, together with the transceiver 1510 and antenna 1534, shown and described above in connection with FIG. 15 may provide a means to receive the first portion of the transmission.

At block 1806, the wireless communication device may select a power splitting factor (PSF) based on the power boosting parameter associated with the transmission. In some examples, the wireless communication device may measure a reference signal received power (RSRP) of the DMRS and select the power splitting factor based on the RSRP of the DMRS and the power boosting parameter. In some examples, the wireless communication device may select a respective power splitting factor for at least two of the plurality of transmissions based on the power boosting parameter (e.g., a single power boosting parameter applicable to all transmissions having the energy harvesting and data reception slot type). In other examples, the wireless communication device may select a respective power splitting factor for the at least two of the plurality of transmissions based on the respective power boosting parameter for each of the at least two of the plurality of transmissions. For example, the EH/data configuration circuitry 1546 shown and described above in connection with FIG. 15 may provide a means to select the PSF.

At block 1808, the wireless communication device may receive a second portion of the transmission at a second power. In some examples, the second portion of the transmission begins in a next symbol following a last DMRS symbol of the set of one or more DMRS symbols. In other examples, the second portion of the transmission begins after an offset relative to the last DMRS symbol of the set of one or more DMRS symbols. The offset can include a number of symbols or a portion of a symbol following the last DMRS symbol. In some examples, the wireless communication device may further receive a configuration of the first portion of the transmission and the second portion of the transmission via a radio resource control message, a medium access control-control element, a sidelink radio resource control message, a sidelink medium access control-control element, or control information. For example, the RF energy harvesting circuit 1530, together with the communication and processing circuitry 1542, transceiver 1510, and antenna 1534 may provide a means to receive the second portion of the transmission.

At block 1810, the wireless communication device may concurrently decode and harvest energy from the second portion of the transmission using a power splitting factor applied to the second power, where the power splitting factor is based on the power boosting parameter. For example, the EH/data configuration circuitry 1546, together with the RF energy harvesting circuit 1530 and the communication and processing circuitry 1542 shown and described above in connection with FIG. 15 may provide a means to concurrently decode and harvest energy from the second portion of the transmission using the power splitting factor.

In one configuration, the wireless communication device 1500 includes means for receiving a message comprising a power boosting parameter indicating a power boosting amount for energy harvesting of a transmission, means for receiving a first portion of the transmission at a first power, means for receiving a second portion of the transmission at a second power higher than the first power, and means for concurrently decoding and harvesting energy from the second portion of the transmission using a power splitting factor applied to the second power, the power splitting factor being based on the power boosting parameter, as described in the present disclosure. In one aspect, the aforementioned means may be the processor 1504 shown in FIG. 15 configured to perform the functions recited by the aforementioned means. In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable storage medium 1506, or any other suitable apparatus or means described in any one of the FIGS. 1, 5, 7, 8, and 11 utilizing, for example, the processes and/or algorithms described herein in relation to FIGS. 11, and/or 16-18.

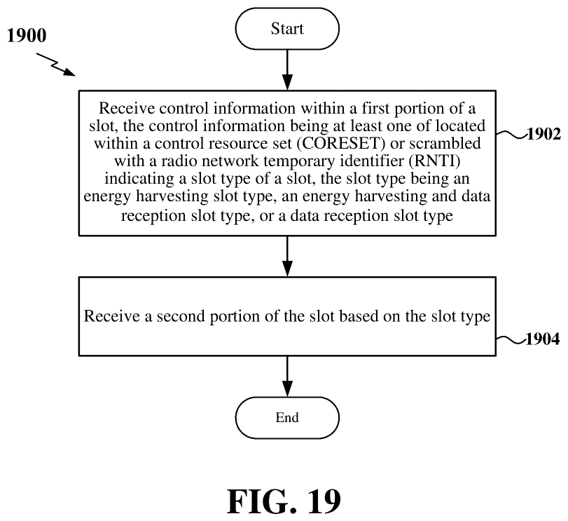

FIG. 19 is a flow chart of a method for identifying a slot type of a slot according to some aspects. As described below, some or all illustrated features may be omitted in a particular implementation within the scope of the present disclosure, and some illustrated features may not be required for implementation of all examples. In some examples, the method may be performed by the wireless communication device 1500, as described above and illustrated in FIG. 15, by a processor or processing system, or by any suitable means for carrying out the described functions.

At block 1902, the wireless communication device (e.g., a UE or other sidelink/V2X/IoT device) may receive control information within a first portion of a slot, the control information being at least one of located within a control resource set (CORESET) or scrambled with a radio network temporary identifier (RNTI) indicating a slot type of a slot, where the slot type is an energy harvesting slot type, an energy harvesting and data reception slot type, or a data reception slot type. In some examples, the control information may include downlink control information or sidelink control information. In some examples, the wireless communication device may further receive a configuration of a plurality of RNTIs, each associated with a respective slot type of a plurality of slot types.

In some examples, the control information may further include scheduling information scheduling a plurality of slots including the slot. In this example, at least one of the CORESET or the RNTI indicates a respective slot type of each of the plurality of slots. In some examples, the control information further includes slot type information indicating a respective slot type of each of the plurality of slots. For example, the slot type information can include a slot-type time division duplex (TDD) pattern or a bitmap indicating the respective slot type of each of the plurality of slots. In some examples, the wireless communication device may further receive a configuration of a plurality of slot-type TDD patterns including the slot-type TDD pattern. For example, the communication and processing circuitry 1542, together with the transceiver 1510 and antenna 1534, shown and described above in connection with FIG. 15, may provide a means to receive the control information.

At block 1904, the wireless communication device may receive a second portion of the slot based on the slot type. In some examples, the wireless communication device may decode the second portion of the slot based on the slot type being the data reception slot type. In other examples, the wireless communication device may harvest energy from the second portion of the slot based on the slot type being the energy harvesting slot type. In other examples, the wireless communication device may concurrently decode and harvest energy from the second portion of the slot based on the slot type being the energy harvesting and data reception slot type. In some examples, the wireless communication device may further receive a power boosting parameter indicating a power boosting amount for energy harvesting and select a power splitting factor to be applied to the second portion of the slot based on the power boosting parameter. For example, the slot identification circuitry 1544, together with the EH/data configuration circuitry 1546, RF energy harvesting circuitry 1530, communication and processing circuitry 1542, transceiver 1510, and antenna 1534, shown and described above in connection with FIG. 15, may provide a means to receive the second portion of the slot based on the slot type.

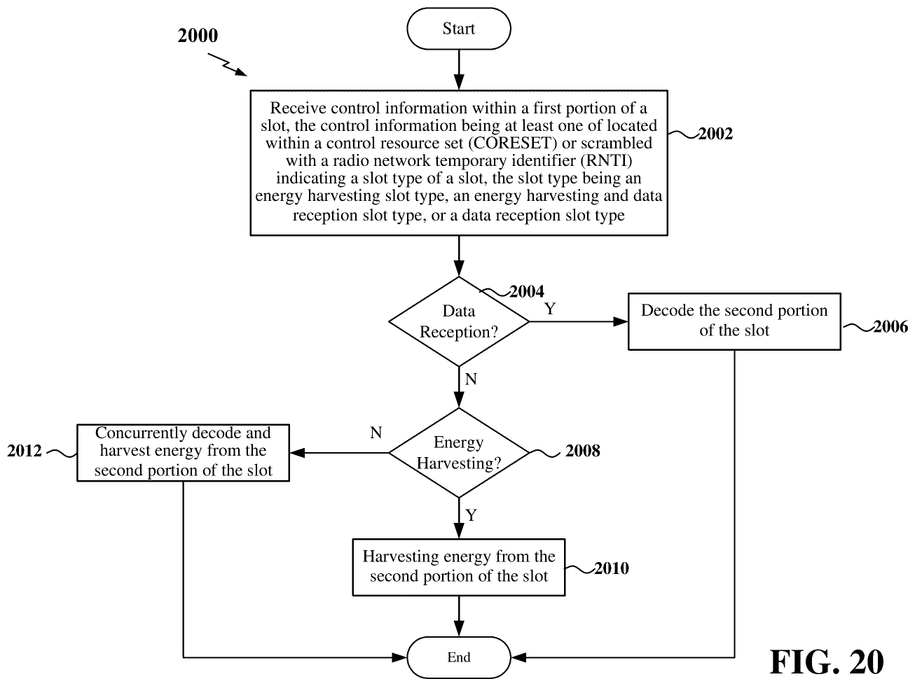

FIG. 20 is a flow chart of a method for processing a slot based on the slot type of the slot according to some aspects. As described below, some or all illustrated features may be omitted in a particular implementation within the scope of the present disclosure, and some illustrated features may not be required for implementation of all examples. In some examples, the method may be performed by the wireless communication device 1500, as described above and illustrated in FIG. 15, by a processor or processing system, or by any suitable means for carrying out the described functions.

At block 2002, the wireless communication device (e.g., a UE or other sidelink/V2X/IoT device) may receive control information within a first portion of a slot, the control information being at least one of located within a control resource set (CORESET) or scrambled with a radio network temporary identifier (RNTI) indicating a slot type of a slot, where the slot type is an energy harvesting slot type, an energy harvesting and data reception slot type, or a data reception slot type. In some examples, the control information may include downlink control information or sidelink control information. In some examples, the wireless communication device may further receive a configuration of a plurality of RNTIs, each associated with a respective slot type of a plurality of slot types. For example, the communication and processing circuitry 1542, together with the transceiver 1510 and antenna 1534, shown and described above in connection with FIG. 15, may provide a means to receive the control information.

At block 2004, the wireless communication device may determine whether the slot type is the data reception slot type. For example, the slot identification circuitry 1544 shown and described above in connection with FIG. 15 may provide a means to determine whether the slot type is the data reception slot type. If the slot type is the data reception slot type (Y branch of block 2004), at block 2006, the wireless communication device may decode the second portion of the slot. For example, the EH/data configuration circuitry 1546, together with the communication and processing circuitry 1542, the transceiver 1510, and antenna 1534, shown and described above in connection with FIG. 15, may provide a means to decode the second portion of the slot.

If the slot type is not the data reception slot type (N branch of block 2004), at block 2008, the wireless communication device may determine whether the slot type is the energy harvesting slot type. For example, the slot identification circuitry 1544 shown and described above in connection with FIG. 15 may provide a means to determine whether the slot type is the energy harvesting slot type. If the slot type is the energy harvesting slot type (Y branch of block 2008), at block 2010, the wireless communication device may harvest energy from the second portion of the slot. For example, the EH/data configuration circuitry 1546, together with the RF energy harvesting circuit 1530 and antenna 1534, shown and described above in connection with FIG. 15 may provide a means to harvest energy from the second portion of the slot.

If the slot type is not the energy harvesting slot type (N branch of block 2008), at block 2012, the wireless communication device may determine that the slot type is the energy harvesting and data reception slot type and may concurrently decode and harvest energy from the second portion of the slot. For example, the EH/data configuration circuitry 1546, together with the slot identification circuitry 1544, RF energy harvesting circuit 1530, communication and processing circuitry 1542, transceiver 1510, and antenna 1534, shown and described above in connection with FIG. 15 may provide a means to concurrently decode and harvest energy from the second portion of the slot.

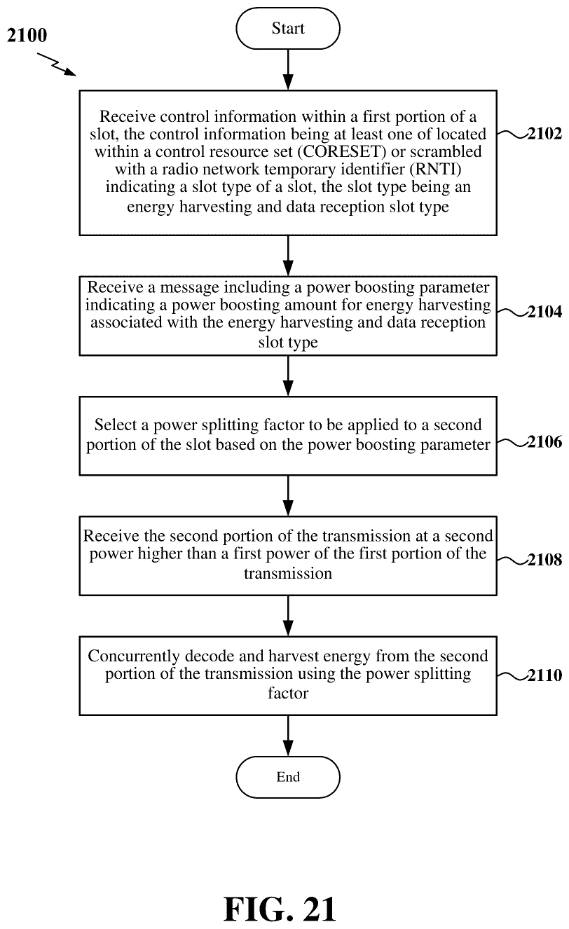

FIG. 21 is a flow chart of a method for applying power boosting to a transmission received within a slot based on the slot type according to some aspects. As described below, some or all illustrated features may be omitted in a particular implementation within the scope of the present disclosure, and some illustrated features may not be required for implementation of all examples. In some examples, the method may be performed by the wireless communication device 1500, as described above and illustrated in FIG. 15, by a processor or processing system, or by any suitable means for carrying out the described functions.

At block 2102, the wireless communication device (e.g., a UE or other sidelink/V2X/IoT device) may receive control information within a first portion of a slot, the control information being at least one of located within a control resource set (CORESET) or scrambled with a radio network temporary identifier (RNTI) indicating a slot type of a slot, where the slot type is an energy harvesting and data reception slot type. In some examples, the control information may include downlink control information or sidelink control information. In some examples, the wireless communication device may further receive a configuration of a plurality of RNTIs, each associated with a respective slot type of a plurality of slot types. For example, the communication and processing circuitry 1542, together with the transceiver 1510 and antenna 1534, shown and described above in connection with FIG. 15, may provide a means to receive the control information.

At block 2104, the wireless communication device may receive a message including a power boosting parameter indicating a power boosting amount for energy harvesting associated with the energy harvesting and data reception slot type. In some examples, the message may include the control information received at block 2102. In other examples, the message may include a radio resource control message, a medium access control-control element, a sidelink radio resource control message, or a sidelink medium access control-control element. For example, the communication and processing circuitry 1542, together with the transceiver 1510 and antenna 1534, shown and described above in connection with FIG. 15, may provide a means to receive the message including the power boosting parameter.

At block 2106, the wireless communication device may select a power splitting factor to be applied to a second portion of the slot based on the power boosting parameter. In some examples, the wireless communication device may measure a reference signal received power (RSRP) of a demodulation reference signal (DMRS) within a set of one or more DMRS symbols of the first portion of the slot and select the power splitting factor based on the RSRP of the DMRS and the power boosting parameter. For example, the EH/data configuration circuitry 1546, shown and described above in connection with FIG. 15 may provide a means to select the power splitting factor.

At block 2108, the wireless communication device may receive a second portion of the transmission at a second power higher than a first power of the first portion of the transmission. For example, the RF energy harvesting circuit 1530, together with the communication and processing circuitry 1542, transceiver 1510, and antenna 1534 shown and described above in connection with FIG. 15 may provide a means to receive the second portion of the transmission.

At block 2110, the wireless communication device may concurrently decode and harvest energy from the second portion of the transmission using the power splitting factor. For example, the EH/data configuration circuitry 1546, together with the RF energy harvesting circuit 1530 and the communication and processing circuitry 1542 shown and described above in connection with FIG. 15 may provide a means to concurrently decode and harvest energy from the second portion of the transmission using the power splitting factor.

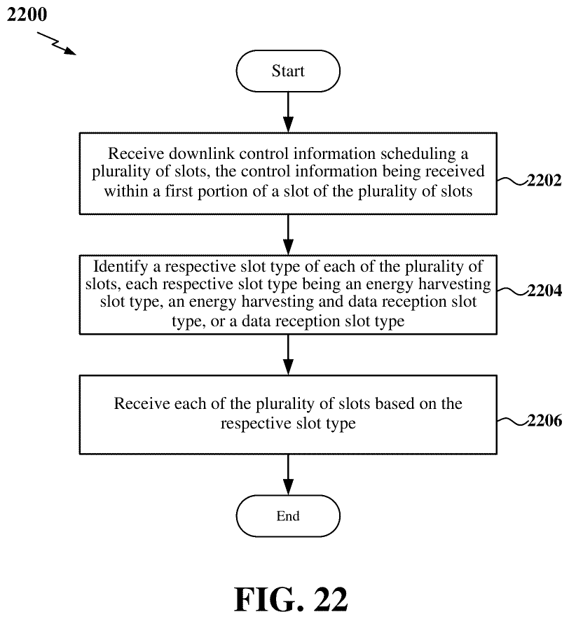

FIG. 22 is a flow chart of a method for receiving a plurality of slots based on the respective slot types of each of the slots according to some aspects. As described below, some or all illustrated features may be omitted in a particular implementation within the scope of the present disclosure, and some illustrated features may not be required for implementation of all examples. In some examples, the method may be performed by the wireless communication device 1500, as described above and illustrated in FIG. 15, by a processor or processing system, or by any suitable means for carrying out the described functions.

At block 2202, the wireless communication device (e.g., a UE or other sidelink/V2X/IoT device) may receive downlink control information scheduling a plurality of slots, where the control information is received within a first portion of a slot of the plurality of slots. For example, the communication and processing circuitry 1542, together with the transceiver 1510 and antenna 1534, shown and described above in connection with FIG. 15, may provide a means to receive the DCI.

At block 2204, the wireless communication device may identify a respective slot type of each of the plurality of slots, each respective slot type being an energy harvesting slot type, an energy harvesting and data reception slot type, or a data reception slot type. In some examples, the downlink control information may be at least one of scrambled with a radio network temporary identifier (RNTI) or located within a control resource set (CORESET) indicating the respective slot type of each of the plurality of transmissions. In other examples, the downlink control information may include slot type information (e.g., a TDD pattern or bitmap) indicating the respective slot type of each of the plurality of transmissions. In other examples, a combination of the RNTI and/or CORESET together with the slot type information included in the downlink control information may indicate the respective slot type associated with each of the plurality of transmissions. For example, the slot identification circuitry 1544, shown and described above in connection with FIG. 15, may provide a means to identify the respective slot type of each of the plurality of slots.

At block 2206, the wireless communication device may receive each of the plurality of slots based on the respective slot type. For example, the wireless communication device may decode each slot for which the slot type is a data reception type. In addition, the wireless communication device may harvest energy from each slot for which the slot type is an energy harvesting slot type. Furthermore, the wireless communication device may concurrently, or in a time-switching manner, decode and harvest energy from each slot for which the slot type is an energy harvesting and data reception slot type. In examples in which the wireless communication device concurrently decodes and harvests energy, the downlink control information may further include a single power boosting parameter applicable to all energy harvesting and data reception slots or a respective power boosting parameter for each of the energy harvesting and data reception slots. The wireless communication device may further select a respective power splitting factor for each of the energy harvesting and data reception slots based on the single power boosting parameter or the respective power boosting parameter. For example, the EH/data configuration circuitry 1546, together with the RF energy harvesting circuit 1530, the communication and processing circuitry 1542, the transceiver 1510, and the antenna 1534, shown and described above in connection with FIG. 15, may provide a means to receive each of the plurality of slots.

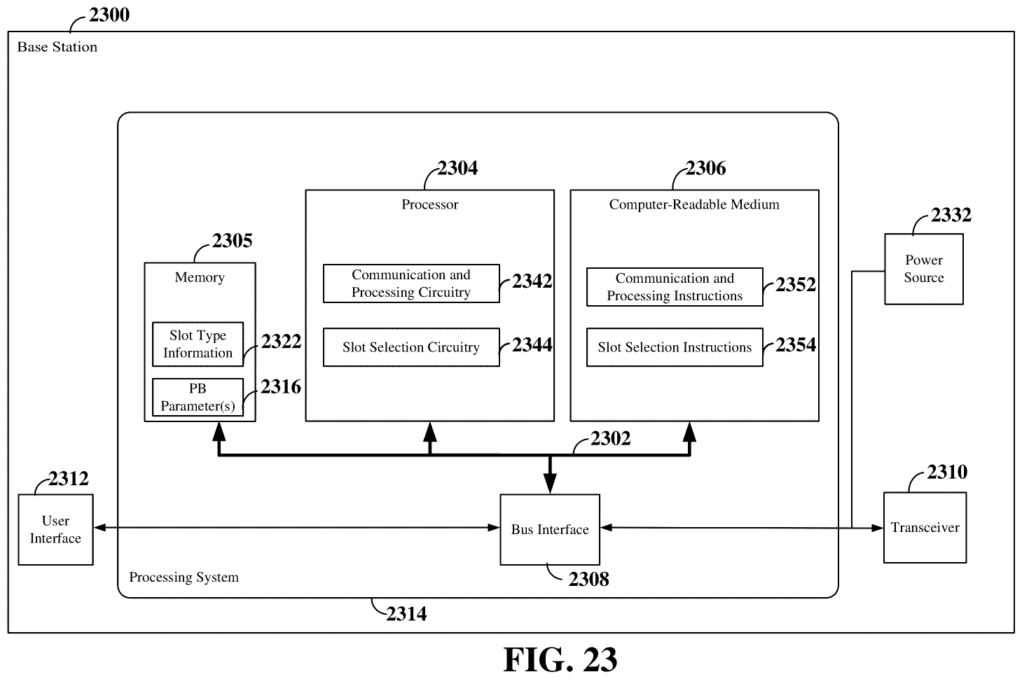

FIG. 23 is a conceptual diagram illustrating an example of a hardware implementation for an exemplary base station 2300 employing a processing system 2314. For example, the base station 2300 may correspond to any of the base stations (e.g., gNBs), scheduling entities, or network transmitting devices shown in any one or more of FIGS. 1, 5, 7, and/or 11 and may include the circuitry shown in FIG. 13.

In accordance with various aspects of the disclosure, an element, or any portion of an element, or any combination of elements may be implemented with a processing system 2314 that includes one or more processors 2304. The processing system 2314 may be substantially the same as the processing system 1514 illustrated in FIG. 15, including a bus interface 2308, a bus 2302, memory 2305, a processor 2304, and a computer-readable medium 2306. Furthermore, the base station 2300 may include an optional user interface 2312, a transceiver 2310, and a power source 2332. The processor 2304, as utilized in a base station 2300, may be used to implement any one or more of the processes described herein.

In some examples, the memory 2305 may store one or more of power boosting (PB) parameter(s) 2316 and slot-type information 2322, which may be used by the processor 2304 in generating and transmitting slots for data decoding and/or energy harvesting by a receiving wireless communication device. In some examples, the slot type information 2322 may include, for example, a list of RNTIs and/or CORESETs, each associated with a respective slot type of a plurality of slot types. In other examples, the slot type information 2322 may include a specific indication of a slot type of a slot or a time division duplex (TDD) pattern or bitmap indicating a respective slot type of a plurality of slots.

The processor 2304 may include communication and processing circuitry 2342 configured to communicate with one or more wireless communication devices via respective Uu links. In some examples, the communication and processing circuitry 2342 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 2342 may include one or more transmit/receive chains.

In some implementations where the communication involves receiving information, the communication and processing circuitry 2342 may obtain information from a component of the base station 2300 (e.g., from the transceiver 2310 that receives the information via radio frequency signaling or some other type of signaling suitable for the applicable communication medium), process (e.g., decode) the information, and output the processed information. For example, the communication and processing circuitry 2342 may output the information to another component of the processor 2304, to the memory 2305, or to the bus interface 2308. In some examples, the communication and processing circuitry 2342 may receive one or more of signals, messages, other information, or any combination thereof. In some examples, the communication and processing circuitry 2342 may receive information via one or more channels. In some examples, the communication and processing circuitry 2342 may include functionality for a means for receiving. In some examples, the communication and processing circuitry 2342 may include functionality for a means for processing, including a means for demodulating, a means for decoding, etc.

In some implementations where the communication involves sending (e.g., transmitting) information, the communication and processing circuitry 2342 may obtain information (e.g., from another component of the processor 2304, the memory 2305, or the bus interface 2308), process (e.g., modulate, encode, etc.) the information, and output the processed information. For example, the communication and processing circuitry 2342 may output the information to the transceiver 2310 (e.g., that transmits the information via radio frequency signaling or some other type of signaling suitable for the applicable communication medium). In some examples, the communication and processing circuitry 2342 may send one or more of signals, messages, other information, or any combination thereof. In some examples, the communication and processing circuitry 2342 may send information via one or more channels. In some examples, the communication and processing circuitry 2342 may include functionality for a means for sending (e.g., a means for transmitting). In some examples, the communication and processing circuitry 2342 may include functionality for a means for generating, including a means for modulating, a means for encoding, etc.

The communication and processing circuitry 2342 may be configured to transmit to a UE, via the transceiver 2310, a message including the PB parameter 2316 indicating a power boosting amount for energy harvesting of a transmission (e.g., downlink transmission). In some examples, the message may include DCI, an RRC message or a MAC-CE. In some examples, the communication and processing circuitry 2342 may be configured to transmit DCI scheduling a plurality of transmissions. In this example, the DCI may include a respective PB parameter 2316 for two or more of the scheduled transmissions. In some examples, the DCI may further include a respective slot type associated with each of the scheduled transmissions. For example, the slot types may include one or more of an energy harvesting slot type, an energy harvesting and data reception slot type, or a data reception slot type.

The communication and processing circuitry 2342 may be configured to transmit a first portion of the transmission at a first power using the power source 2332. In some examples, the first portion of the transmission may include a DMRS within a set of one or more DMRS symbols of the transmission. The set of one or more DMRS symbols may include, for example, at least a first DMRS symbol within a PDSCH transmission, PSSCH transmission or a SCI-2 transmission, or may include one or more DMRS symbols within a DCI transmission or SCI-1 transmission. The communication and processing circuitry 2342 may further be configured to transmit a power boosting mode indicating whether the set of one or more symbols is within a PDSCH transmission, a PSSCH transmission, a DCI transmission, an SCI-1 transmission, or an SCI-2 transmission. The communication and processing circuitry 2342 may further be configured to transmit a second portion of the transmission at a second power higher than the first power using the power source 2332.

In some examples, the second portion of the transmission begins in a next symbol following a last DMRS symbol of the set of one or more DMRS symbols of the first portion of the transmission. In other examples, the second portion begins after an offset relative to the last DMRS symbol (or first DMRS symbol) of the set of one or more DMRS symbols of the first portion of the transmission. For example, the offset can include a number of symbols of a portion of a symbol following the last DMRS symbol. In some examples, the communication and processing circuitry 2342 may further be configured to transmit a configuration of the first portion of the transmission and the second portion of the transmission via an RRC message, a MAC-CE, or control information (e.g., DCI). For example, the configuration may include a number of symbols in the first portion of the transmission and a number of symbols in the second portion of the transmission. In other examples, the configuration may indicate the offset from the first/last DMRS symbol in the first portion of the transmission.

In some examples, the communication and processing circuitry 2342 may further be configured to transmit control information (e.g., PDCCH including DCI) associated with the transmission within a slot. The control information may be associated with the slot type information 2322. For example, the control information may be at least one of scrambled with an RNTI or located within a CORESET indicating that the slot is an energy harvesting slot that further carries data associated with the transmission.

In some examples, the communication and processing circuitry 2342 may be configured to transmit control information (e.g., DCI) within a first portion of a slot. The control information may be associated with the slot type information 2322. For example, the control information may be at least one of located within a CORESET or scrambled with an RNTI indicating a slot type of the slot. The slot type may include an energy harvesting slot type, an energy harvesting and data reception slot type, or a data reception slot type. In some examples, the communication and processing circuitry 2342 may further be configured to transmit a configuration of a plurality of RNTIs, each associated with a respective slot type of a plurality of slot types.

In some examples, the control information may further include scheduling information scheduling a plurality of slots including the slot. In this example, at least one of the CORESET or the RNTI may indicate a respective slot type of each of the plurality of slots based on the slot type information 2322. In other examples, the control information further includes the slot type information 2322 indicating the respective slot type of each of the plurality of slots. For example, the slot type information 2322 may include a slot-type TDD pattern or a bitmap indicating the respective slot type of each of the plurality of slots. In some examples, the communication and processing circuitry 2342 may further be configured to transmit a configuration of a plurality of slot-type TDD patterns including the slot-type TDD pattern. The communication and processing circuitry 2342 may further be configured to execute communication and processing instructions (software) 2352 stored in the computer-readable medium 2306 to implement one or more of the functions described herein.

The processor 2304 may further include slot selection circuitry 2344, configured to select a slot type of one or more slots based on the slot type information 2322. For example, the slot selection circuitry 2344 may be configured to select the slot type of the slot and further generate control information for the slot based on the slot type information 2322 for the slot based associated with the control information. For example, the control information may specifically include the slot type information 2322 (e.g., a specific indication of the slot type of the slot). As another example, the control information may be at least one of scrambled with an RNTI or located within a CORESET that indicates the slot type based on the slot type information 2322.

In examples in which the control information schedules a plurality of slots, the slot selection circuitry 2344 may be configured to select the slot type of each of the plurality of slots and generate the control information based on the selected slot types. For example, the control information may be at least one of scrambled with an RNTI or located within a CORESET that indicates the slot types of the plurality of slots based on the slot type information 2322. As another example, the control information may include a TDD pattern or bitmap indicating the slot type of each of the plurality of slots based on the slot type information 2322. The slot selection circuitry 2344 may further be configured to execute slot selection instructions (software) 2354 stored in the computer-readable medium 2306 to implement one or more of the functions described herein.

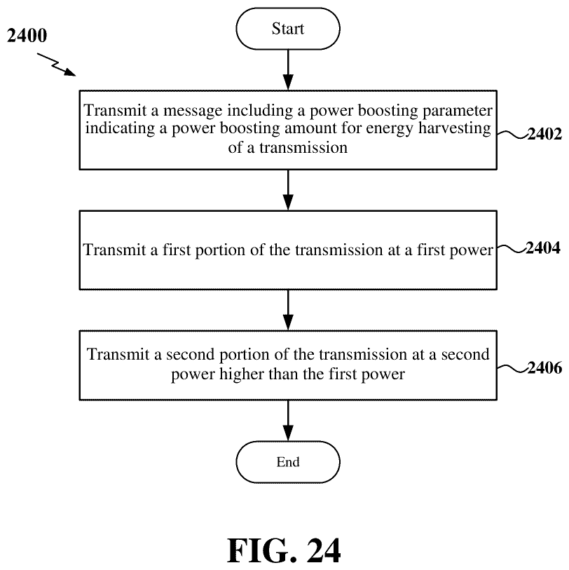

FIG. 24 is a flow chart of an exemplary method 2400 for power boosting for shared data and energy harvesting symbols according to some aspects. As described below, some or all illustrated features may be omitted in a particular implementation within the scope of the present disclosure, and some illustrated features may not be required for implementation of all examples. In some examples, the method may be performed by the base station 2300, as described above and illustrated in FIG. 23, by a processor or processing system, or by any suitable means for carrying out the described functions.

At block 2402, the base station may transmit a message including a power boosting parameter indicating a power boosting amount for energy harvesting of a transmission. In some examples, the message may include downlink control information, a radio resource control message, or a medium access control-control element. In some examples, the message may include control information (e.g., DCI) scheduling a plurality of transmissions including the transmission. In some examples, the control information further includes a respective power boosting parameter for at least two of the plurality of transmissions. In some examples, the control information further indicates a respective slot type associated with each of the plurality of transmissions, where the respective slot type includes an energy harvesting slot type, an energy harvesting and data reception slot type, or a data reception slot type. For example, the communication and processing circuitry 2342, together with the transceiver 2310, shown and described above in connection with FIG. 23, may provide a means to transmit the message including the power boosting parameter.

At block 2404, the base station may transmit a first portion of the transmission at a first power. In some examples, the base station may transmit a demodulation reference signal (DMRS) within a set of one or more DMRS symbols of the first portion of the transmission. In some examples, the set of one or more DMRS symbols includes at least a first DMRS symbol within a physical downlink shared channel (PDSCH) transmission. In other examples, the set of one or more DMRS symbols is within a downlink control information (DCI) transmission. In some examples, the base station may further transmit a power boosting mode indicating whether the set of one or more DMRS symbols is within a physical downlink shared channel (PDSCH) transmission, a downlink control information (DCI) transmission, a physical sidelink shared channel (PSCCH) transmission, a first stage sidelink control information (SCI-1) transmission, or a second stage SCI (SCI-2) transmission. In some examples, the base station may transmit control information (e.g., DCI) associated with the transmission within a slot, where the control information is at least one of scrambled with a radio network temporary identifier (RNTI) or located within a control resource set (CORESET) indicating the slot is an energy harvesting slot that further carries data associated with the transmission. For example, the communication and processing circuitry 2342, together with the transceiver 2310, shown and described above in connection with FIG. 23 may provide a means to transmit the first portion of the transmission.

At block 2406, the base station may transmit a second portion of the transmission at a second power higher than the first power. In some examples, the second portion of the transmission begins in a next symbol following a last DMRS symbol of the set of one or more DMRS symbols. In other examples, the second portion of the transmission begins after an offset relative to the last DMRS symbol (or first DMRS symbol) of the set of one or more DMRS symbols. The offset can include a number of symbols or a portion of a symbol following the last DMRS symbol. In some examples, the base station may further transmit a configuration of the first portion of the transmission and the second portion of the transmission via a radio resource control message, a medium access control-control element, or control information. For example, the communication and processing circuitry 2342 and transceiver 2310 shown and described above in connection with FIG. 23 may provide a means to transmit the second portion of the transmission.

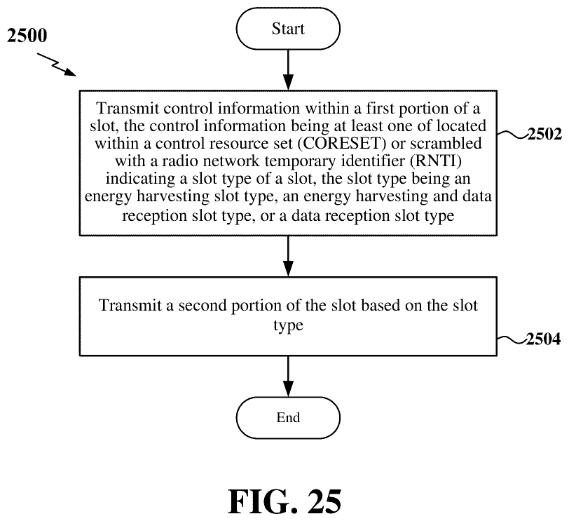

FIG. 25 is a flow chart of a method for indicating a slot type of a slot according to some aspects. As described below, some or all illustrated features may be omitted in a particular implementation within the scope of the present disclosure, and some illustrated features may not be required for implementation of all examples. In some examples, the method may be performed by the base station 2300, as described above and illustrated in FIG. 23, by a processor or processing system, or by any suitable means for carrying out the described functions.

At block 2502, the base station may transmit control information within a first portion of a slot, the control information being at least one of located within a control resource set (CORESET) or scrambled with a radio network temporary identifier (RNTI) indicating a slot type of a slot, where the slot type is an energy harvesting slot type, an energy harvesting and data reception slot type, or a data reception slot type. In some examples, the control information may include downlink control information. In some examples, the base station may further transmit a configuration of a plurality of RNTIs, each associated with a respective slot type of a plurality of slot types.

In some examples, the control information may further include scheduling information scheduling a plurality of slots including the slot. In this example, at least one of the CORESET or the RNTI indicates a respective slot type of each of the plurality of slots. In some examples, the control information further includes slot type information indicating a respective slot type of each of the plurality of slots. For example, the slot type information can include a slot-type time division duplex (TDD) pattern or a bitmap indicating the respective slot type of each of the plurality of slots. In some examples, the base station may further transmit a configuration of a plurality of slot-type TDD patterns including the slot-type TDD pattern. For example, the communication and processing circuitry 2342, together with the slot selection circuitry 2344, and transceiver 2310, shown and described above in connection with FIG. 23, may provide a means to transmit the control information.

At block 2504, the base station may transmit a second portion of the slot based on the slot type. In some examples, the base station may further transmit a power boosting parameter indicating a power boosting amount for energy harvesting. For example, the communication and processing circuitry 2342, together with the slot selection circuitry 2344 and transceiver 2310, shown and described above in connection with FIG. 23, may provide a means to transmit the second portion of the slot based on the slot type.

The processes shown in FIGS. 16-22, 24, and 25 may include additional aspects, such as any single aspect or any combination of aspects described below and/or in connection with one or more other processes described elsewhere herein.

Aspect 1: A method for wireless communication at a wireless communication device, the method comprising: receiving a message comprising a power boosting parameter indicating a power boosting amount for energy harvesting of a transmission; receiving a first portion of the transmission at a first power; receiving a second portion of the transmission at a second power higher than the first power; and concurrently decoding and harvesting energy from the second portion of the transmission using a power splitting factor applied to the second power, the power splitting factor being based on the power boosting parameter.

Aspect 2: The method of aspect 1, wherein the message comprises downlink control information, a radio resource control message, or a medium access control-control element.

Aspect 3: The method of aspect 1, wherein the message comprises sidelink control information, a sidelink radio resource control message, or a sidelink medium access control-control element.

Aspect 4: The method of any of aspects 1 through 3, wherein the receiving the first portion of the transmission comprises: receiving a demodulation reference signal (DMRS) within a set of one or more DMRS symbols of the first portion of the transmission; measuring a reference signal received power (RSRP) of the DMRS; and selecting the power splitting factor based on the RSRP of the DMRS and the power boosting parameter.

Aspect 5: The method of aspect 4, wherein the second portion of the transmission begins in a next symbol following a last DMRS symbol of the set of one or more DMRS symbols.

Aspect 6: The method of aspect 4, wherein the second portion of the transmission begins after an offset relative to a last DMRS symbol of the set of one or more DMRS symbols, wherein the offset comprises a number of symbols or a portion of a symbol following the last DMRS symbol.

Aspect 7: The method of any of aspects 4 through 6, wherein the set of one or more DMRS symbols comprises at least a first DMRS symbol within either a physical downlink shared channel (PDSCH) transmission, a physical sidelink shared channel (PSSCH) transmission, or a second stage sidelink control information (SCI-2) transmission.

Aspect 8: The method of any of aspects 4 through 6, wherein the set of one or more DMRS symbols is within a downlink control information (DCI) transmission or a first stage sidelink control information (SCI-1) transmission.

Aspect 9: The method of any of aspects 4 through 8, further comprising: receiving a power boosting mode indicating whether the set of one or more DMRS symbols is within a physical downlink shared channel (PDSCH) transmission, a physical sidelink shared channel (PSSCH) transmission, a downlink control information (DCI) transmission, a first stage sidelink control information (SCI-1) transmission, or a second stage SCI (SCI-2) transmission.

Aspect 10: The method of any of aspects 1 through 9, further comprising: receiving a configuration of the first portion of the transmission and the second portion of the transmission via a radio resource control message, a medium access control-control element, a sidelink radio resource control message, a sidelink medium access control-control element, or control information.

Aspect 11: The method of any of aspects 1 through 10, further comprising: receiving control information associated with the transmission within a slot, the control information being at least one of scrambled with a radio network temporary identifier (RNTI) or located within a control resource set (CORESET) indicating the slot is an energy harvesting slot that further carries data associated with the transmission.

Aspect 12: The method of aspect 11, wherein the control information comprises downlink control information or sidelink control information.

Aspect 13: The method of aspect 11 or 12, wherein the message comprises control information scheduling a plurality of transmissions including the transmission.

Aspect 14: The method of aspect 13, further comprising: selecting a respective power splitting factor for at least two of the plurality of transmissions based on the power boosting parameter.

Aspect 15: The method of aspect 13, wherein the control information further comprises a respective power boosting parameter for at least two of the plurality of transmissions, and further comprising: selecting a respective power splitting factor for the at least two of the plurality of transmissions based on the respective power boosting parameter for each of the at least two of the plurality of transmissions.

Aspect 16: The method of aspect 13, wherein the control information indicates a respective slot type associated with each of the plurality of transmissions, the respective slot type comprising an energy harvesting slot type, an energy harvesting and data reception slot type, or a data reception slot type.

Aspect 17: A method for wireless communication at a wireless communication device, the method comprising: receiving control information within a first portion of a slot, the control information being at least one of located within a control resource set (CORESET) or scrambled with a radio network temporary identifier (RNTI) indicating a slot type of a slot, the slot type comprising an energy harvesting slot type, an energy harvesting and data reception slot type, or a data reception slot type; and receiving a second portion of the slot based on the slot type.

Aspect 18: The method of aspect 17, wherein the receiving the second portion of the slot further comprises: decoding the second portion of the slot based on the slot type being the data reception slot type.

Aspect 19: The method of aspect 17, wherein the receiving the second portion of the slot further comprises: harvesting energy from the second portion of the slot based on the slot type being the energy harvesting slot type.

Aspect 20: The method of aspect 17 wherein the receiving the second portion of the slot further comprises: concurrently decoding and harvesting energy from the second portion of the slot based on the slot type being the energy harvesting and data reception slot type.

Aspect 21: The method of aspect 20, further comprising: receiving a power boosting parameter indicating a power boosting amount for energy harvesting; and selecting a power splitting factor to be applied to the second portion of the slot based on the power boosting parameter.

Aspect 22: The method of any of aspects 17 through 21, further comprising: receiving a configuration of a plurality of RNTIs, each associated with a respective slot type of a plurality of slot types.

Aspect 23: The method of any of aspects 17 through 22, wherein the control information comprises downlink control information or sidelink control information.

Aspect 24: The method of any of aspects 17 through 23, wherein the control information comprises scheduling information scheduling a plurality of slots including the slot.

Aspect 25: The method of aspect 24, wherein at least one of the CORESET or the RNTI indicates a respective slot type of each of the plurality of slots.

Aspect 26: The method of aspect 24, wherein the control information further comprises slot type information indicating a respective slot type of each of the plurality of slots.

Aspect 27: The method of aspect 26, wherein the slot type information comprises a slot-type time division duplex (TDD) pattern or a bitmap indicating the respective slot type of each of the plurality of slots.

Aspect 28: The method of aspect 26, further comprising: receiving a configuration of a plurality of slot-type TDD patterns including the slot-type TDD pattern.

Aspect 29: A wireless communication device configured for wireless communication comprising a transceiver, a memory, and a processor coupled to the transceiver and the memory, the processor and the memory being configured to perform the method of any of aspects 1 through 16 or 17 through 27.

Aspect 30: A wireless communication device configured for wireless communication and comprising means for performing the method of any of aspects 1 through 16 or 17 through 27.

Aspect 31: An article of manufacture comprising a non-transitory computer-readable medium having instructions stored therein executable by one or more processors of a wireless communication device to perform the method of any of aspects 1 through 16 or 17 through 27.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-25 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 5, 7, 8, 11, 13, 15, and/or 23 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A wireless communication device configured for wireless communication, comprising:
a transceiver;
a memory; and
a processor coupled to the transceiver and the memory, the processor and the memory being configured to:
receive a message comprising a power boosting parameter indicating a power boosting amount for energy harvesting of a transmission via the transceiver;
receive a first portion of the transmission at a first power via the transceiver;
receive a second portion of the transmission at a second power higher than the first power via the transceiver; and
concurrently decode and harvest energy from the second portion of the transmission using a power splitting factor applied to the second power, the power splitting factor being based on the power boosting parameter.

2. The wireless communication device of claim 1, wherein the message comprises downlink control information, a radio resource control message, or a medium access control-control element.

3. The wireless communication device of claim 1, wherein the message comprises sidelink control information, a sidelink radio resource control message, or a sidelink medium access control-control element.

4. The wireless communication device of claim 1, wherein the processor and the memory are further configured to:
receive a demodulation reference signal (DMRS) within a set of one or more DMRS symbols of the first portion of the transmission;
measure a reference signal received power (RSRP) of the DMRS; and
select the power splitting factor based on the RSRP of the DMRS and the power boosting parameter.

5. The wireless communication device of claim 4, wherein the second portion of the transmission begins in a next symbol following a last DMRS symbol of the set of one or more DMRS symbols.

6. The wireless communication device of claim 4, wherein the second portion of the transmission begins after an offset relative to a last DMRS symbol of the set of one or more DMRS symbols, wherein the offset comprises a number of symbols or a portion of a symbol following the last DMRS symbol.

7. The wireless communication device of claim 4, wherein the set of one or more DMRS symbols comprises at least a first DMRS symbol within either a physical downlink shared channel (PDSCH) transmission, a physical sidelink shared channel (PSSCH) transmission, or a second stage sidelink control information (SCI-2) transmission.

8. The wireless communication device of claim 4, wherein the set of one or more DMRS symbols is within a downlink control information (DCI) transmission or a first stage sidelink control information (SCI-1) transmission.

9. The wireless communication device of claim 4, wherein the processor and the memory are further configured to:
receive a power boosting mode indicating whether the set of one or more DMRS symbols is within a physical downlink shared channel (PDSCH) transmission, a physical sidelink shared channel (PSSCH) transmission, a downlink control information (DCI) transmission, a first stage sidelink control information (SCI-1) transmission, or a second stage SCI (SCI-2) transmission.

10. The wireless communication device of claim 1, wherein the processor and the memory are further configured to:
receive a configuration of the first portion of the transmission and the second portion of the transmission via a radio resource control message, a medium access control-control element, a sidelink radio resource control message, a sidelink medium access control-control element, or control information.

11. The wireless communication device of claim 1, wherein the processor and the memory are further configured to:
receive control information associated with the transmission within a slot, the control information being at least one of scrambled with a radio network temporary identifier (RNTI) or located within a control resource set (CORESET) indicating the slot is an energy harvesting slot that further carries data associated with the transmission.

12. The wireless communication device of claim 11, wherein the control information comprises downlink control information or sidelink control information.

13. The wireless communication device of claim 1, wherein the message comprises control information scheduling a plurality of transmissions including the transmission.

14. The wireless communication device of claim 13, wherein the processor and the memory are further configured to:
select a respective power splitting factor for at least two of the plurality of transmissions based on the power boosting parameter.

15. The wireless communication device of claim 13, wherein the control information further comprises a respective power boosting parameter for at least two of the plurality of transmissions, and wherein the processor and the memory are further configured to:
select a respective power splitting factor for the at least two of the plurality of transmissions based on the respective power boosting parameter for each of the at least two of the plurality of transmissions.

16. The wireless communication device of claim 13, wherein the control information indicates a respective slot type associated with each of the plurality of transmissions, the respective slot type comprising an energy harvesting slot type, an energy harvesting and data reception slot type, or a data reception slot type.

17. A wireless communication device configured for wireless communication, comprising:
a transceiver;
a memory; and
a processor coupled to the transceiver and the memory, the processor and the memory being configured to:
receive control information within a first portion of a slot via the transceiver, the control information being at least one of located within a control resource set (CORESET) or scrambled with a radio network temporary identifier (RNTI) indicating a slot type of a slot, the slot type comprising an energy harvesting slot type, an energy harvesting and data reception slot type, or a data reception slot type; and
receive a second portion of the slot based on the slot type via the transceiver.

18. The wireless communication device of claim 17, wherein the processor and the memory are further configured to:
decode the second portion of the slot based on the slot type being the data reception slot type.

19. The wireless communication device of claim 17, wherein the processor and the memory are further configured to:
harvest energy from the second portion of the slot based on the slot type being the energy harvesting slot type.

20. The wireless communication device of claim 17, wherein the processor and the memory are further configured to:
concurrently decode and harvest energy from the second portion of the slot based on the slot type being the energy harvesting and data reception slot type.

21. The wireless communication device of claim 20, wherein the processor and the memory are further configured to:
receive a power boosting parameter indicating a power boosting amount for energy harvesting; and
select a power splitting factor to be applied to the second portion of the slot based on the power boosting parameter.

22. The wireless communication device of claim 17, wherein the processor and the memory are further configured to:
receive a configuration of a plurality of RNTIs, each associated with a respective slot type of a plurality of slot types.

23. The wireless communication device of claim 17, wherein the control information comprises downlink control information or sidelink control information.

24. The wireless communication device of claim 17, wherein the control information comprises scheduling information scheduling a plurality of slots including the slot.

25. The wireless communication device of claim 24, wherein at least one of the CORESET or the RNTI indicates a respective slot type of each of the plurality of slots.

26. The wireless communication device of claim 24, wherein the control information further comprises slot type information indicating a respective slot type of each of the plurality of slots.

27. The wireless communication device of claim 26, wherein the slot type information comprises a slot-type time division duplex (TDD) pattern or a bitmap indicating the respective slot type of each of the plurality of slots.

28. The wireless communication device of claim 26, wherein the processor and the memory are further configured to:
receive a configuration of a plurality of slot-type TDD patterns including the slot-type TDD pattern.

29. A method for wireless communication at a wireless communication device, the method comprising:
receiving a message comprising a power boosting parameter indicating a power boosting amount for energy harvesting of a transmission;
receiving a first portion of the transmission at a first power;
receiving a second portion of the transmission at a second power higher than the first power; and
concurrently decoding and harvesting energy from the second portion of the transmission using a power splitting factor applied to the second power, the power splitting factor being based on the power boosting parameter.

30. A method for wireless communication at a wireless communication device, the method comprising:
receiving control information within a first portion of a slot, the control information being at least one of located within a control resource set (CORESET) or scrambled with a radio network temporary identifier (RNTI) indicating a slot type of a slot, the slot type comprising an energy harvesting slot type, an energy harvesting and data reception slot type, or a data reception slot type; and
receiving a second portion of the slot based on the slot type.
